(19) United States
(12) Patent Application Publication
(10) Pub. No.: US 2007/0151615 A1
(43) Pub. Date: Jul. 5, 2007

(54) Bulk fluid flow gate

(75) Inventors: David Strand, Sherborn, MA (US); Daniel M. Leatzow, Butte, MT (US)

Correspondence Address: BANNER & WITCOFF, LTD., 28 STATE STREET, 28th FLOOR, BOSTON, MA, 02109-9601, US

(73) Assignee: Protasis Corporation, Marlborough, MA (US)

(21) Appl. No.: 10/557,536

(22) PCT Filed: May 19, 2004
(86) PCT No.: PCT/US04/15934

§ 371 Date: Jan. 12, 2007

Related U.S. Application Data
(60) Provisional application No. 60/471,639, filed on May 19, 2003.

(51) Int. Cl. F15C 1/04

(52) U.S. Cl. 137/827

(57) ABSTRACT

A bulk fluid flow gate is provided. In accordance with certain exemplary embodiments the bulk fluid flow gate includes a first and second entry port and first and second exit ports. Bulk fluid is flowed into the chamber to provide greater hydrodynamic resistance at the first exit port than at the second exit port. The bulk fluid flow gate is useful for separation, testing and or analysis of analytes. Methods of making and using the bulk fluid flow gate are also provided. In accordance with certain exemplary embodiments a fluid flow gate includes a first entry port to a microscale chamber and first and second exit ports. In accordance with certain exemplary embodiments a fluid flow gate includes a first entry port to a chamber and first and second exit ports, wherein greater hydrodynamic resistance is provided at the first exit port than at the second exit port.

### CROSS-REFERENCED APPLICATIONS

The present application relates to commonly assigned provisional patent applications U.S. Application Ser. No. 60/440,150, entitled “Devices and Methods for Focusing Analytes in an Electric Field Gradient,” filed on 15 Jan. 2003 (attorney docket number 005092.00038); U.S. Application Ser. No. 60/440,105, entitled “Method and Apparatus for Determining the Isoelectric Point of a Charged Analyte,” filed on 15 Jan. 2003 (attorney docket number 005092.00039); U.S. Application Ser. No. 60/430,943, entitled “Electrophoresis Device, System and Method for Sample Management and Hyphenation of Analytical Instruments,” filed on Dec. 2, 2002 (attorney docket number 005092.00037); U.S. Application Ser. No. 60/447,997, entitled “Electrophoresis Device, System and Method for Sample Management and Hyphenation of Analytical Instruments,” filed on Feb. 18, 2003 (attorney docket number 005092.00042); U.S. Application Ser. No. 60/471,616, entitled “Electrophoresis Device, System and Method for Sample Management and Hyphenation of Analytical Instruments,” filed on May 19, 2003 (attorney docket number 005092.00049); U.S. Application Ser. No. 60/471,681, entitled “Method and Apparatus for Determining the Isoelectric Point of a Charged Analyte,” filed on May 19, 2003 (attorney docket number 005092.00046); U.S. Application Ser. No. 60/471,597, entitled “Devices and Methods for Focusing Analytes in an Electric Field Gradient,” filed on May 19, 2003 (attorney docket number 005092.00047); U.S. Application Ser. No. 60/471,623, entitled “Electrophoresis Devices and Methods for Focusing Charged Analytes,” filed on May 19, 2003 (attorney docket number 005092.00048); or in U.S. Application Ser. No. 60/471,595, entitled “Electrophoresis Devices and Methods for Focusing Charged Analytes,” filed on May 19, 2003 (attorney docket number 005092.00050), and commonly assigned published PCT applications WO 0228531 entitled “Fluid Separation Conduit Cartridge With Encryption Capability,” WO 0228509 entitled “Fluid Separation Conduit Cartridge,” WO 0228532 entitled “Microfluidic Substrate Assembly And Method For Making Same,” WO 02056049 entitled “Microfluidic Device With Multiple Microcoil NMR Detectors,” and WO 0244744 entitled “Steep Solvent Gradient NMR Analysis Method,” the entire disclosure of each of which his hereby incorporated by reference in its entirety for all purposes.

### FIELD OF THE INVENTION

The present invention is directed to a bulk fluid flow gate. Some examples or embodiments of the invention are directed to a bulk fluid flow gate that is useful in testing, separation and analytical devices.

### BACKGROUND

Electrically driven separations processes for analysis of complex mixtures have become widely accepted throughout the field of biotechnology, and electrophoresis-based devices continue to find widespread use in on-going proteomic investigations. The popularity of electrophoresis stems from the technique's ability to resolve target molecules on the basis of small differences in molecular weight, electrophoretic mobilities, isoelectric points, or combinations of these properties.

There is a need for sample management devices, systems and methods to analyze and test samples. Accordingly, it is an object of this invention to provide a bulk fluid flow gate useful in separation, testing and analysis of one or more analytes.

### SUMMARY

In accordance with a first aspect, a bulk fluid flow gate is provided, that is operative to generate a hydrodynamic force and an opposed electric field in a flow cell, and is useful in analysis, testing and/or separation of one or more analytes. The bulk fluid flow gates comprises a first fluid flow chamber; and

at least one electrode operative when energized to generate an electric field in the first fluid flow chamber. The first fluid flow chamber comprises a first fluid inlet port configured to receive bulk fluid flow into the first fluid flow chamber, a first fluid outlet port configured to pass bulk fluid from the first chamber, a second fluid inlet port configured to receive sample fluid flow into the first fluid flow chamber at a location between the first fluid inlet port and the first fluid outlet port, and a second fluid outlet port configured to pass fluid from the first fluid flow chamber. The first fluid outlet port and the second fluid outlet port are on opposite sides of the first fluid inlet port. The bulk fluid flow gate, when receiving a bulk fluid flow into the first fluid flow chamber via the first fluid inlet port and simultaneously a sample fluid flow into the first fluid flow chamber via the second inlet port, presents greater hydrodynamic resistance to passing fluid from the first fluid flow chamber via the second outlet port than via the first fluid outlet port. The chamber optionally can be a packed chamber or unpacked. Any suitable packing can be used, of which many are commercially available and well known to those skilled in the art. The electric field can be a constant electric field, i.e., a uniform field, or a gradient electric field, i.e., a field whose strength varies along the chamber. In either case the electric field can be a static electric field during all or a selected period of processing, or a dynamic electric field, that is, a field whose shape is changeable with time use of the device.

In accordance with a second aspect, the bulk fluid flow gate includes at least a first chamber that is configured to experience an electric field, as discussed in more detail below. The first chamber typically includes a plurality of ports. The first chamber includes a first entry port for introducing bulk fluid into the first chamber and a first exit port for exiting of bulk fluid from the first chamber. The first chamber also includes a second entry port positioned between the first entry port and the first exit port, i.e., the second entry port is positioned downstream of the first entry port. The second entry port is for introducing sample into the first chamber. As discussed in more detail below, the sample typically includes one or more analytes, e.g., charged and/or uncharged analytes. The first chamber further includes a second exit port which typically is positioned upstream of the first entry port. That is, the second exit port is typically positioned upstream from the point where bulk fluid is introduced into the first chamber so that the hydrodynamic resistance at the second exit port is substantially less than the hydrodynamic resistance at the first exit port.

In accordance with another aspect, the first chamber experiences an electric field. In certain examples, the electric field is generated using a single electrode, which may or may not be polarized, in communication with the first chamber. In other examples, the electric field is generated using a pair of electrodes. In yet other examples, the electric field is generated using an electrode array. Numerous examples below discuss the use of a single electrode, pairs of electrodes and electrode arrays. In addition, the person of ordinary skill in the art, given the benefit of this disclosure, will readily be able to select other suitable methods and devices for generating an electric field that is experienced by the first chamber. The electric field is designed to provide a motive force such that at least some analytes of the sample migrate in a direction that is substantially opposite the direction of bulk fluid flow. In certain examples, the electric field strength is selected such that some of the analytes can migrate against bulk fluid flow and exit upstream of the first entry port. In some examples, when the electric field drives the analyte with a greater force than the hydrodynamic force, the analyte will migrate upstream towards the second exit port of the first chamber.

In accordance with another aspect, the first entry port of the first chamber introduces bulk flow into the first chamber. The bulk flow generates a hydrodynamic force directed substantially towards the first exit port. The first exit port experiences substantially greater hydrodynamic resistance than the second exit port. In certain examples, the first entry port is configured at substantially a ninety-degree angle to the axial direction of the first chamber. In other examples, the first port is configured at an obtuse angle, i.e., greater than 90 degrees and less than 180 degrees, to the axial direction of the first chamber. In yet other examples, the first port is moveable from an angle of about 90 degrees to an obtuse angle. Such movements typically are controlled electronically by a microprocessor or the like. One skilled in the art, given the benefit of this disclosure, will be able to select suitable first entry port angles depending on an intended use of the bulk fluid flow gate.

In accordance with other aspects, the second entry port of the first chamber introduces sample into the first chamber. The sample typically includes one or more analytes dissolved in a suitable solvent. The composition of the solvent may be the same or different from the composition of bulk fluid introduced through the first entry port. The samples can be introduced through the second entry port using numerous methods and devices including syringes, pumps, injectors and the like. In certain examples, the sample is introduced using an auto-injector. The person of ordinary skill in the art, given the benefit of this disclosure, will be able to select suitable devices and methods for introducing samples into the first chamber of the devices disclosed here.

In accordance with another aspect, the first exit port is positioned downstream from the first entry port and downstream from the second entry port. As bulk fluid is introduced from the first entry port, the bulk fluid flows into the first chamber at a suitable velocity and volume such that greater hydrodynamic resistance exists at the first exit port than at the second exit port. A result of this greater hydrodynamic resistance is that an analyte proximate to the first exit port experiences great resistance to migration away from the first exit port. That is, the hydrodynamic force makes it difficult for the analyte to migrate upstream towards the second exit port. In certain examples it may be necessary to increase the electric field strength, decrease the hydrodynamic resistance, or both, such that the analyte can migrate towards the second exit port. The person of ordinary skill in the art, given the benefit of this disclosure, will be able to select suitable hydrodynamic resistances and electric field strengths.

In accordance with yet other aspects, the second exit port is located upstream from the first entry port, the second entry port and the first exit port. A result of such location is that the second exit port experiences substantially lower hydrodynamic resistance than that experienced at the first exit port. Analytes that are positioned between the first entry port and the second exit port experience little hydrodynamic resistance and can exit the first chamber rapidly. Such decrease in hydrodynamic resistance may be linear, exponential, logarithmic or the like, and depends at least in part on the parameters selected, e.g., bulk flow velocity, electric field strength, etc., and the selected dimensions and shape of the first chamber. As discussed in more detail below, in examples where an analyte has migrated from the second entry port to the first entry port, the hydrodynamic resistance experienced by the analyte drops significantly once the analyte clears the first entry port.

In accordance with other aspects, the ports of the first chamber may be configured in numerous orientations with respect to the first chamber. In certain examples as discussed above, the first entry port and the second entry port each is configured at about a ninety-degree angle to the axial direction of the first chamber. In certain examples, the first entry port is configured at an obtuse angle, i.e., greater than ninety degrees and less than 180 degrees, to the axial direction of the first chamber. In certain examples, each of the first and second exit ports is parallel to the axial direction of the first chamber. As discussed below, other orientations are possible and will be recognized by the person of ordinary skill in the art given the benefit of this disclosure.

In accordance with certain aspects, the electric field is generated by at least one electrode. The electrode provides a driving force such that charged analytes migrate away from or towards the electrode. The electrode can be positively or negatively charged, but typically the electrode comprises a charge suitable to drive the analyte away from the electrode. In examples where the analyte is positively charged, the electrode is also positively charged to repel the analyte and drive the analyte away from the electrode. Without wishing to be bound by any particular scientific theory, it may be necessary or desirable to include a second electrode so that the bulk fluid flow gate operates for an intended purpose.

In accordance with other aspects, a pair of electrodes is used to generate an electric field, where one electrode of the electrode pair is typically positioned at one end of the bulk fluid flow gate and the second electrode of the electrode pair is typically positioned at an opposite end of the bulk fluid flow gate. Typically, one electrode of the electrode pair is positively charged and the other electrode of the electrode pair is negatively charged. Charged analyte introduced into the first chamber through the second entry port typically will migrate towards the electrode bearing an opposite charge to that of the analyte. However, as discussed further below, in certain examples the charge of one or more analytes may be altered or masked such that migration occurs in a direction that is substantially opposite the native charge of the analyte. It will be within the ability of the person of ordinary skill in the art, given the benefit of this disclosure, to select suitable operating conditions to achieve a desired result.

In accordance with other aspects, the electric field generated by the electrode(s) of the bulk fluid flow gate may be a constant or linear electric field or may be an electric field gradient of any suitable strength and shape, e.g., parabolic, segmented (i.e., having two or more segments each with a different slope), etc. In accordance with other aspects, the electrode chamber of the devices disclosed here comprises an electrode array. The electrode array comprises more than two electrodes, for example, 3 or more electrodes, e.g., about 3 to 50 electrodes or more. The electrodes, typically are arranged uniformly or non-uniformly along the axial length of the first chamber, e.g., the electrodes of the array may be spaced evenly throughout the electrode chamber or can have any suitable spacing selected by a user. It will be within the ability of those skilled in the art, given the benefit of this disclosure, to select a suitable number and spacing of electrodes, chamber shape (for both the separation chamber and the electrode chamber) to achieve the desired electric field shape and strength and the desired degree of control of electric field shape and strength. The electrodes can be microfabricated electrodes, e.g., microfabricated bio-electrodes. The electrodes can be protected electrodes, requiring no membrane between the separation chamber and the electrode chamber or simply positioned in the separation chamber. Each such electrode generally has a protective coating or membrane exclusionary of the target analyte and sufficiently permeable to electric current to establish the desired electric field in the separation chamber, optionally a porous membrane, e.g., an ion-exchange membrane. A via or porous material can be used to release gasses evolved at the electrode during operation. Each electrode is optionally capable of being individually controlled, i.e., energized at a level selected independently of the energization level of other electrodes in the array. In certain aspects, the electrode array is independently operative to generate an electric field gradient profile, that is to say, the electrode array can create a gradient in the electric field, the shape and/or strength of which is then acted upon by the non-uniformity of the separation chamber, the electrode(s), or both. In cern examples, the electrode array is operative to generate an electric field gradient profile in the first chamber that can be dynamically controlled. In other examples, the voltages of the electrodes of the electrode array typically are individually monitored and controlled to influence the shape and/or strength of the electric field gradient, with or without adjustment or change during the focusing process. Optionally, for example, the voltage applied to each electrode is controlled by a computer-controlled circuit board or suitable processor or the like in operative connection to a suitable voltage source. In certain examples, the electrode array is used to dynamically control the electric field gradient during migration of one or more analytes, for example, to shift the location of a stationary focused band within the first chamber to bring the band over an optional sampling port located on the first chamber from which the band(s) can be selectively removed.

In accordance with certain aspects, an external electric field may be applied to remove any imperfections in the electric field or the electric field gradient generated by the second chamber. In certain examples, it may be desirable to have a homogeneous electric field throughout the first chamber. To achieve a homogeneous electric field, an external electric field can be applied to remove any imperfections in the field generated by the electrode(s) or electrode array(s). Suitable methods for removing any imperfections in the generated electric field will be readily apparent to those skilled in the art, given the benefit of this disclosure.

In accordance with certain aspects, the first chamber can be designed to be uniform or non-uniform. A first chamber that is uniform typically has a substantially constant cross-sectional area in the axial direction. A first chamber that is non-uniform typically has a variable cross-sectional area in the axial direction. Similarly, each of the ports of the first chamber may be uniform or non-uniform. Uniform ports typically have a substantially constant cross-sectional area in the axial direction. Non-uniform ports typically have a variable cross-sectional area in the axial direction. In certain examples, the bulk fluid flow gate may include a uniform first chamber and uniform ports. In other examples, the bulk fluid flow gate may include a non-uniform first chamber and one or more uniform ports. In yet other examples, the bulk fluid flow gate may include a uniform first chamber and one or more non-uniform ports. In yet further examples, the bulk fluid flow gate may include a non-uniform chamber and one or more non-uniform ports. Depending on the intended use of the bulk fluid flow gate, the person of ordinary skill in the art, given the benefit of this disclosure, will be able to select and design bulk fluid flow gates including uniform first chambers, non-uniform first chambers and uniform and/or non-uniform ports.

In certain examples, the first chamber is a separation chamber designed to facilitate separation of analytes in a sample. As discussed in more detail below, the first chamber may include one or more separation media, e.g., chromatography media including but not limited to molecular sieves, ion-exchange media, size exclusion media, etc., for separation of the analytes in the sample.

In accordance with a method aspect, a method of using the bulk fluid flow gate is provided. The method comprises providing a bulk fluid flow gate as described herein. The bulk fluid flow gate typically includes at least one electrode for generating an electric field, a first chamber in communication with the at least one electrode, the first chamber comprising a first entry port, a first exit port, a second entry port positioned between the first entry port and the first exit port, and a second exit port, introducing a sample comprising at least one charged analyte into the first chamber through the second entry port; applying an electric field to the first chamber; and introducing bulk fluid into the first chamber through the first entry port, in which the bulk fluid flows substantially against direction of migration of the at least one charged analyte in the electric field of the first chamber, the bulk fluid flowing with sufficient hydrodynamic force such that the hydrodynamic resistance at the first exit port is substantially greater than the hydrodynamic resistance at the second exit port. During operation of the bulk fluid flow gate, in the absence of any electric field, sample introduced into through the second entry port, is carried by bulk fluid introduced through the first entry port and exits through the first exit port. When an electric field is generated, sample introduced into the first chamber through the second entry port may be carried by the bulk fluid and exit through the first exit port or may migrate against bulk fluid flow and exit the second exit port, which is upstream of the first entry port. The bulk fluid flow gate is operative to select which analytes exit upstream of bulk fluid flow and which analytes flow with bulk fluid and exit downstream of bulk fluid flow.

In accordance with other aspects, during operation of the bulk fluid flow gate, the velocity or volume of bulk fluid introduced through the first port can vary to increase or reduce the hydrodynamic force at different portions of the first chamber. In addition, the strength of the electric field may be varied such that retardation of analyte migration by the bulk fluid may be overcome. That is, the electric field strength can be increased so that even in the presence of bulk fluid flow, analytes can migrate towards the second exit port. It will be within the ability of the person skilled in the art, given the benefit of this disclosure, to select suitable bulk fluid velocities and volumes and suitable electric field strengths depending on an intended use of the bulk fluid flow gate.

In accordance with yet other aspects, systems are provided comprising the bulk fluid flow gate. The systems typically include a bulk fluid flow gate, an injector and one or more detectors. The systems typically are used to separate, test and/or detect analytes.

In accordance with another method aspect, a method of making a bulk fluid flow gate is provided. Typically, the bulk fluid flow gate is assembled in the form of a laminate, as discussed in the published PCT applications incorporated by reference in their entirety and as also discussed in the commonly assigned provisional applications incorporated herein by reference.

It will be recognized that the bulk fluid flow gate provided here represents a significant technological advance. The bulk fluid flow gate can direct analytes into selected ports for further analyses and/or testing. It will be within the ability of those skilled in the art, given the benefit of this disclosure, to select and design suitable bulk fluid flow gates for an intended use.

### BRIEF DESCRIPTION OF THE DRAWINGS

Examples of the bulk fluid flow gate disclosed here are discussed below with reference to the accompanying drawings in which:

FIG. 1a is a cross-sectional view of a first example of a bulk fluid flow gate;

FIGS. 1b and 1c are each a cross-sectional view of an example of the first chamber of the bulk fluid flow gate;

FIGS. 1d-1h are each a cross-sectional view of an example of a non-uniform first chamber;

FIG. 1i is a cross-sectional view of a first chamber comprising an entry port including a rounded elbow;

FIG. 2a is a schematic view of a first example of a bulk fluid flow gate;

FIG. 2b is a schematic view of a second example of a bulk fluid flow gate;

FIG. 3A is an exploded view of another example of the devices disclosed here;

FIGS. 3B-3E are schematic perspective views of selected components of the device illustrated in FIG. 3A;

FIG. 4 is an elevation view, partly in section, of the device of FIGS. 3A-3E in assembly;

FIGS. 5A and 5B are front and back plan views, respectively, of the device of FIGS. 3A-3E and 4, in assembly;

FIGS. 6A and 6B are views, partially in section, of the device of FIGS. 3A-3E, 4 and 5A-5B, in assembly, taken through line 6A-6A in FIG. 4 and line 6B-6B in FIGS. 5A and 5B, respectively;

There are no FIGS. 7-12

FIGS. 13A-13F present schematic representations and graphical representations of two approaches for conducting electric field gradient focusing in accordance with certain examples of the devices and methods disclosed here;

FIG. 14 is a schematic drawing of another example of a device in accordance with the present disclosure;

FIGS. 15A and 15B each is a graphical representation of the field strength profile and potential profile, respectively, of a linear field gradient (15.5 v/cm²) in accordance with another example of the methods and devices disclosed here;

FIG. 16 is a schematic representation of the resistance between two adjacent electrodes in another example of the methods and devices disclosed here;

FIG. 17 is a schematic diagram of a representative electric field gradient focusing gradient control model of an example of the methods and devices disclosed here;

FIG. 18 is a schematic diagram of a representative electric field gradient focusing gradient control circuits;

FIG. 19 is a circuit diagram of a representative controller unit;

FIG. 20 is a circuit diagram of a representative controller unit;

FIG. 21 is a schematic illustration of a representative DAC board circuit diagram illustrating connections,

FIG. 22 is a schematic illustration of a representative DAC board circuit diagram illustrating components;

There are no FIGS. 23-24.

FIG. 25 is a schematic illustration of representative configurations for other examples of the device.

FIGS. 26a-26c show use of the bulk fluid flow gate for an exemplary separation.

FIGS. 27a-27b show use of the bulk fluid flow gate for another exemplary separation.

The dimensions, sizes, shapes and configurations of the figures are only representative of exemplary devices disclosed here. Other suitable dimensions, sizes, shapes and configurations will be readily selected by the person of ordinary skill in the art, given the benefit of this disclosure.

### DETAILED DESCRIPTION OF CERTAIN EXAMPLES

It will be recognized by the person of ordinary skill in the art that the devices and methods disclosed here can be used for innumerable applications. For convenience purposes only and without limiting the scope of the claims in any manner, the devices and methods described in the examples below are intended for use in separation, focusing and/or testing of analytes for subsequent isolation, analysis and/or for introduction into a suitable instrument, analytical device, or other selected device.

Unless otherwise indicated or unless otherwise clear from the context in which it is described, the elements or features disclosed in the examples below and in the examples discussed in the Summary should be understood to be interchangeable with each other. That is, one or more elements described in one example may be interchanged or substituted for one or more elements described in another example. The elements of the examples should be understood to be disclosed generally for use with other aspects and examples of the devices and methods disclosed herein.

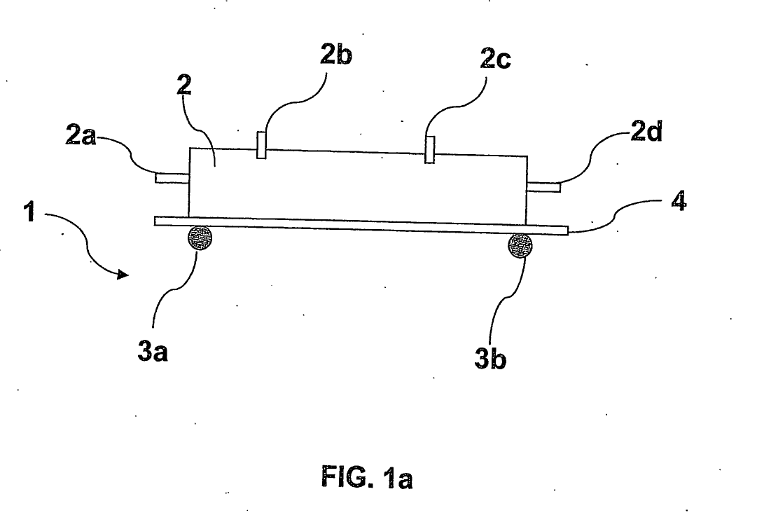

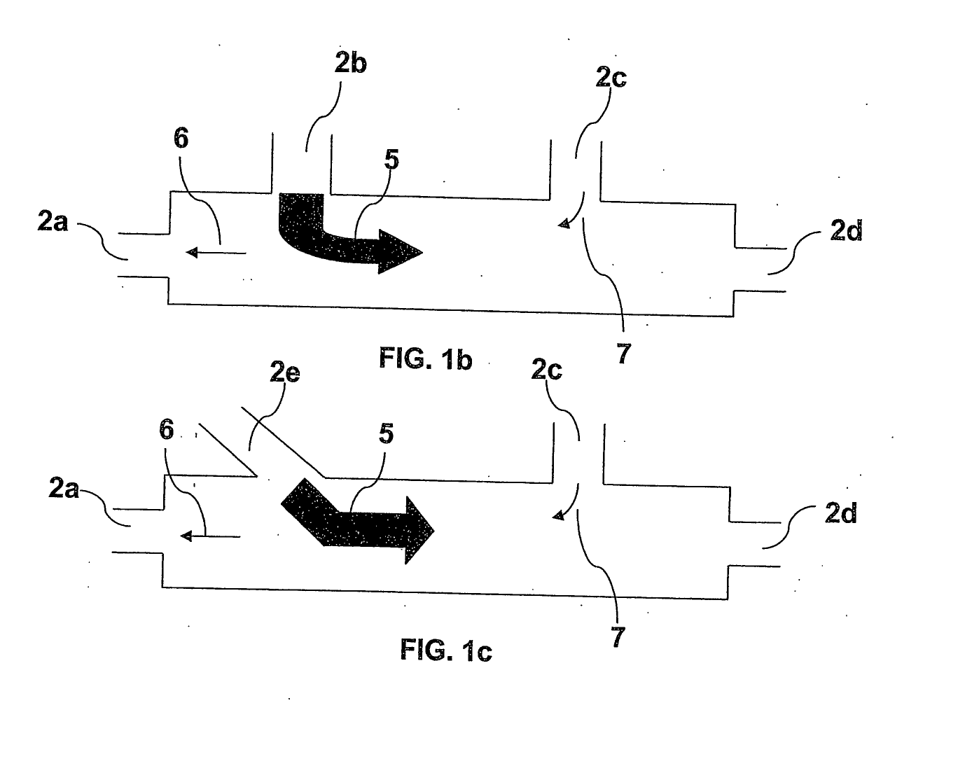

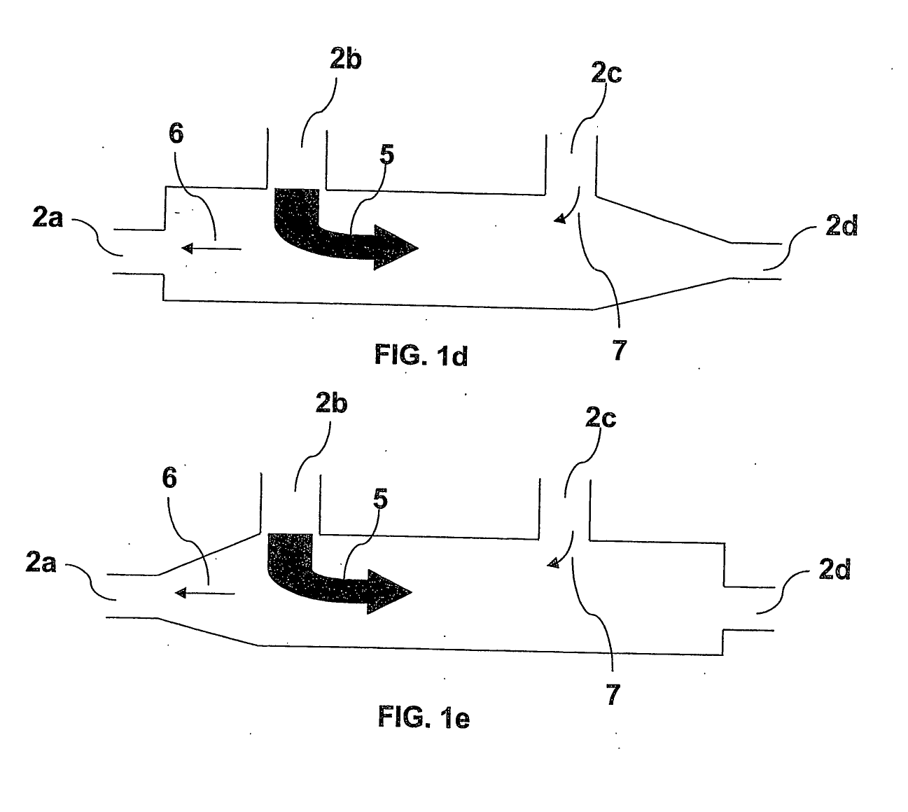

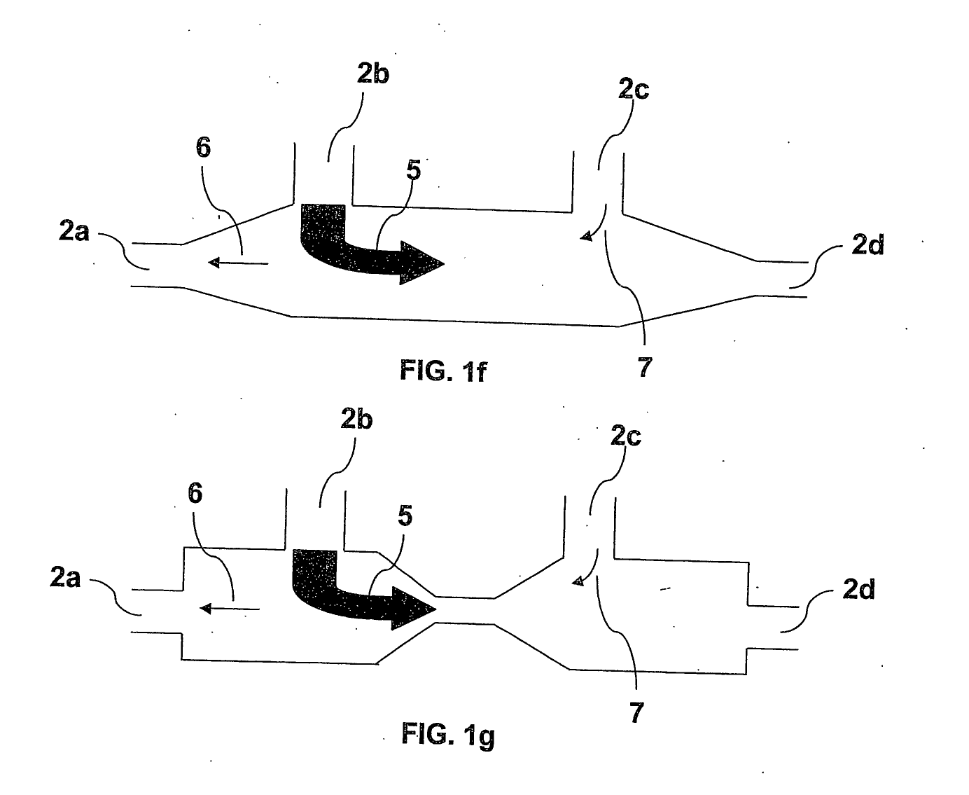

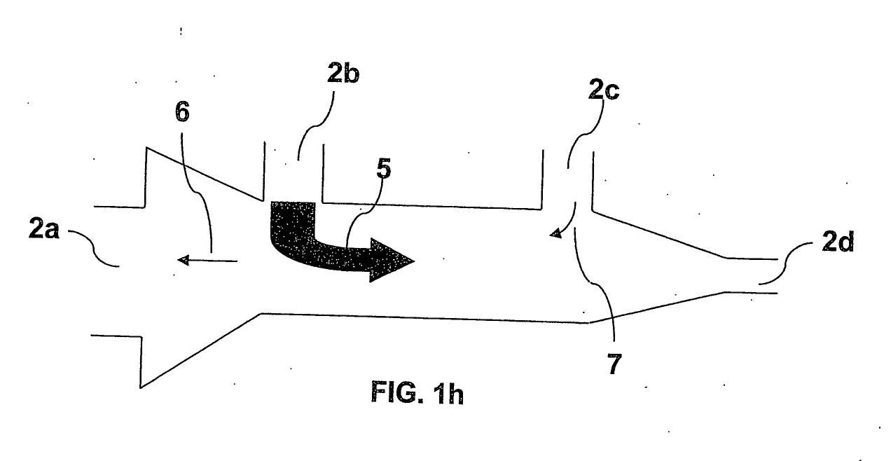

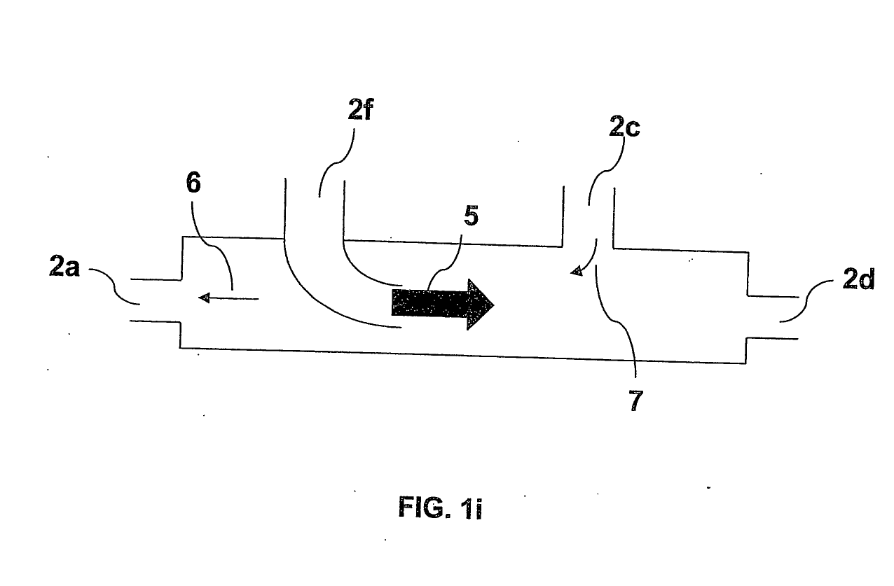

In certain examples, a bulk fluid flow gate 1 (see FIG. 1a) includes a first chamber 2 and a pair of electrodes 3a and 3b. The first chamber 2 includes first entry port 2b, second entry port 2c, first exit port 2a and second exit port 2d. Second entry port 2c is typically positioned between first entry port 2b and first exit port 2d. The bulk fluid flow gate typically also includes a first permeable material 4 that separates the first chamber 2 and electrodes 3a and 3b, which are operative to generate an electric field which is experienced by the first chamber and which drives migration of analytes introduced into the first chamber. First chamber 2 is in electrical communication and mass or ionic communication with electrodes 3a and 3b through permeable material 4. “Electrical communication” or “the electric field being experienced by the first chamber” refers to the ability of the electric field that is generated by the electrode(s) to be transferred, or to have an effect, within the first chamber, and may be by any means which accomplishes this result. The permeable material retains analytes in the first chamber and is permeable to certain analytes such that the electrodes and first chamber are in communication as noted above.

In certain examples, bulk fluid 5 is introduced into the first chamber 2 through first entry port 2b (see FIG. 1b). Introduction of bulk fluid results in substantially greater hydrodynamic resistance downstream of first entry port 2b such that the hydrodynamic resistance at first exit port 2d is greater than the hydrodynamic resistance at second exit port 2a. Fluid flow 6, which is upstream or first entry port 2b typically is of a lower volume and/or velocity than bulk fluid flow 5 such that the hydrodynamic resistance at second exit port 2a is substantially less than the hydrodynamic resistance at first exit port 2d. Sample 7 is introduced into first chamber 2 through second entry port 2c.

In the device shown in FIGS. 1a and 1b and in the presence of an electric field, charged analytes in sample 7 migrate either towards first exit port 2d or second exit port 2a. Charged analyte that is migrating towards first exit port 2d is aided in migration by bulk fluid flow. Charged analyte that is migrating towards second exit port 2a is retarded in migration by bulk fluid flow because bulk fluid flows in a substantially opposing direction to analytes migrating towards second exit port 2a. That is, bulk fluid flow 5 acts to retard migration of sample 7 towards second exit port 2a, and during migration of analyte in the first chamber, once the analyte migrates upstream of first entry port 2b, the retarding force exerted on the analyte by the bulk fluid flow is substantially reduced. Fluid 6 flows in a substantially opposite direction to that of bulk fluid 5. Bulk fluid flow acts as a gate to retard migration of sample introduced downstream of first entry port 2b, and once analyte migrates upstream of first entry port 2b, i.e., upstream of the gate, the hydrodynamic force and the migration force are substantially in the same direction.

In certain examples, first entry port 2e can be positioned at an obtuse angle to the axial direction of first chamber 2 (see FIG. 1c). A result of such positioning of first entry port 2e at an obtuse angle is that bulk fluid is directed substantially towards first exit port 2d. First exit port 2d experiences greater hydrodynamic resistance that second exit port 2a, which is upstream of first entry port 2e. The velocity of fluid 6, which is upstream of first entry port 2e, is substantially lower than the velocity of bulk fluid flow 5, and fluid 6 flows in a substantially opposite direction to bulk fluid 5. The gating effect is substantially reduced once analyte migrates upstream of first entry port 2e.

In certain examples, the strength of opposing forces, e.g., the hydrodynamic force generated by bulk fluid and the migration force generated by the electric field, are selected to control the rate at which sample migrates in the first chamber. In certain examples, the electric field is kept substantially constant and the velocity and/or volume of bulk fluid is varied until a desired separation is achieved or until analyte migrates at a suitable migration rate. In other examples, the hydrodynamic force is kept substantially constant and the strength of the electric field is selected such that analyte migrates with a suitable migration rate. In yet other examples, both the hydrodynamic force and the migration force are varied such that analyte migrates with a selected migration rate. It will be within the ability of the person skilled in the art, given the benefit of this disclosure, to select suitable bulk fluid velocities and volumes and electric field strengths to control the migration rates of one or more charged analytes.

In accordance with certain examples, the devices disclosed here include a first block comprising a first trough in communication with the first entry port and the second entry port and in communication with the first exit port and second exit port. A second block has a second trough with an inlet for introducing a second liquid to the second trough and an outlet for exiting the second liquid from the second trough. The second trough further comprises an electrode, an electrode pair or an electrode array positioned in the second trough, wherein the first trough and the second trough are substantially coincident and form a channel when the first block is sealed to the second block. A permeable material is provided intermediate the first and second blocks, dividing the channel formed when the first block is sealed to the second block into a first chamber and an electrode housing. The device as such is in the configuration of a discrete unit, or “chip” or consumable cartridge, for example a microfluidic cartridge, which can be swapped out of a suitable receptacle in a laboratory or processing instrument or the like.

In certain examples, the first chamber of the bulk fluid flow gate includes a non-uniform cross-sectional flow channel, that is to say, the cross-sectional area of the separation chamber varies axially along the channel. For example, FIG. 1d shows a first chamber that has a non-uniform cross-sectional flow channel. The cross-sectional area of the first chamber decreases from second entry channel 2c and towards first exit port 2d. FIG. 1e shows a non-uniform first chamber in which the cross-sectional area decreases from first entry port 2b towards second exit port 2a. FIG. 1f shows a non-uniform first chamber in which the cross-sectional area of first chamber decreases from first entry port 2b to second exit port 2a, and the cross-sectional area of the first chamber also decreases from second entry port 2c towards first entry port 2d. FIG. 1f shows a non-uniform first chamber in which the cross-sectional area decreases at a point between first entry port 2b and second entry port 2c. FIG. 1g shows a non-uniform first chamber in which the cross-sectional area of the first chamber increases from first entry port 2b and towards second exit port 2a, and in which the cross-sectional area decreases from second entry port 2c towards first exit port 2d. The person of ordinary skill in the art, given the benefit of this disclosure, will be able to select these and other non-uniform chambers for an intended use of the bulk fluid flow gate. The first chamber in certain examples has a substantially uniform height (height here meaning the direction normal to the plane of the membrane) and a non-uniform or non-constant width (width here meaning the direction perpendicular to the overall direction of flow and parallel to the plane of the membrane). In other examples, the first chamber has a substantially uniform width and a varying or non-uniform height. Yet other examples employ a first chamber of non-uniform width and non-uniform height. Other examples include a first chamber defined by one or more non-linear walls, for example, a series of faces or facets, some or all having non-uniform dimensions; or wherein the first chamber has a curved cross-section, such as, for example, a half-circular cross-section, that varies axially, as, for example, a half-cone-shaped chamber.

In certain examples, one or more ports of the bulk fluid flow gate may comprise an elbow (see FIG. 1i). For example, first entry port 2f may be in the general shape of a rounded elbow such that bulk fluid introduced into first entry port flows substantially downstream towards first exit port 2d. The ports of the bulk fluid flow gates disclosed here may also include elbows, adapters, fittings, tees, junctions and the like. It will be within the ability of the person of ordinary skill in the art to design suitable ports for use in the bulk fluid flow gates disclosed here.

In certain examples, the electrode(s) of the bulk fluid flow gate generates an electric field that is communicated to the first chamber. Charged analytes introduced into the first chamber typically migrate towards or away from the electrode. Charged species having a charge substantially similar to the charge on the electrode typically migrate away from the electrode, whereas charged species having a charge substantially opposite to the charge on the electrode migrate towards the electrode. In examples where only a single electrode is in communication with the first chamber, it may be necessary to position a second electrode outside of the bulk fluid flow gate for proper operation of the bulk fluid flow gate. One skilled in the art, given the benefit of this disclosure, will be able to select and configure bulk fluid flow gates for an intended use.

In certain examples, the first chamber is in electrical communication with a pair of electrodes. The electrode pair typically is oppositely charged such that analytes migrate towards one of the electrodes of the electrode pair. In a typical arrangement, the negatively charged electrode of the electrode pair is placed downstream near the first exit port and the positively charged electrode is placed upstream near the second exit port. Without wishing to be bound by any particular scientific theory, because many biomolecules are negatively charged at physiological pH, biomolecules will migrate against bulk fluid flow towards the second exit port. One skilled in the art, given the benefit of this disclosure, will be able to select suitable electrode charges in the bulk fluid flow gates disclosed here.

In other examples, the first chamber comprises a uniform or non-uniform tube, with one or more electrodes plated on the interior surface of the tube and coated with a porous, conductive coating. In those embodiments described here that comprise a porous membrane, the membrane is at least conductive in that it does not prevent the electric field in the chamber and it is porous in the sense that it is permeable to buffer species or the like without allowing contact of the target analyte with the electrodes. In certain embodiments, the membrane does not substantially affect the electric field generated by the electrodes and does not affect the electric field experienced by the separation chamber. The porous coating is chosen such that it allows small molecules such as buffer ions to pass but prohibits molecules of the size of the analytes from passing through and contacting the electrodes. In yet other examples, the first chamber comprises a porous, uniform or non-uniform tube, with electrodes plated on the exterior of the tube. The porous tube is likewise chosen to be porous to small molecules and to prohibit passage of molecules of the size of the analyte(s). Other suitable configurations of the bulk fluid flow gate will be readily apparent to the person of ordinary skill in the art, given the benefit of the present disclosure.

In certain examples, the non-uniformity of the first chamber induces a gradient in the electric field. The non-uniformity of the first chamber further leads to a gradient in the hydrodynamic force that exists as a result of flowing bulk fluid through the chamber. It will be within the ability of the person of ordinary skill in the art given the benefit of this disclosure, to select desired shapes for the chamber, desired electric field strengths and desired hydrodynamic forces.

In other examples, the electrode(s) of the bulk fluid flow gate may be made of suitable conductive materials including but not limited to ionically conductive materials, electronic conductive materials, protonic conductive materials and the like. Exemplary electrodes include, for example, electrodes comprising platinum, palladium, gold, copper, conductive polymer, such as graphite-polymer composites and the like, indium tin oxide (“ITO”), other oxides, and mixtures thereof. Other suitable electrode materials will be readily selected by the person of ordinary skill in the art, given the benefit of the present disclosure.

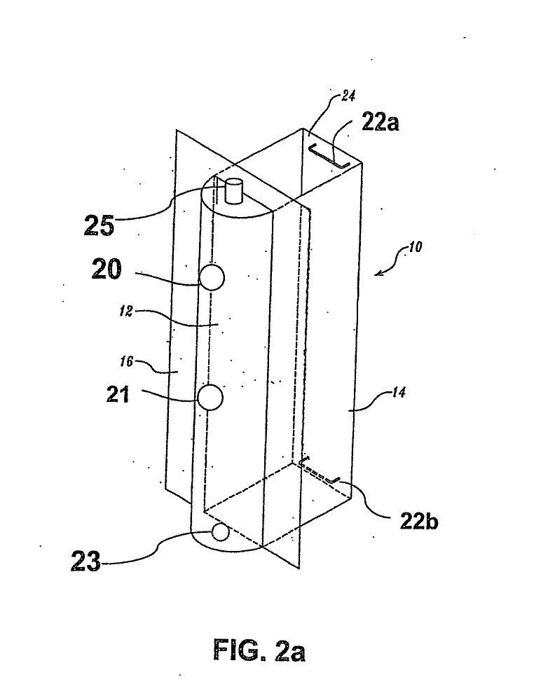

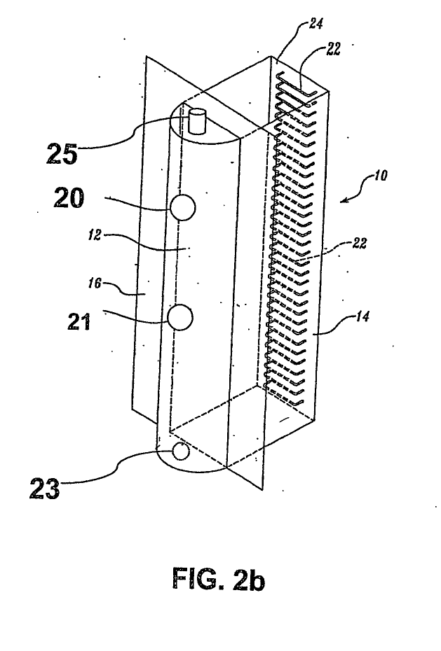

In accordance with other examples, a schematic view of a bulk fluid flow gate is shown in FIG. 2a The bulk fluid flow gate 10 includes first chamber 12 and an electrode housing 14 separated by permeable member 16. First chamber includes a first entry port 20, a second entry port 21, a first exit port 23 and a second exit port 25. In operation, at least in certain examples, bulk fluid flow flows downward from first entry port 20 through chamber 12 exiting first exit port 23. In certain examples, it may be necessary to flow coolant buffer through electrode housing 14, either upwardly or downwardly. Electrode housing 14 includes a first electrode 22a and a second electrode 22b. As shown in FIG. 2a, the electrodes can be positioned at opposite ends of chamber 12 and permeable member 16. In certain examples when the device of FIG. 2a is used to purify a sample or separate analytes in a sample, sample is introduced into second entry port 21 and bulk fluid is introduced into first entry port 20. Analyte that migrates upward towards electrode 22a can exit the first chamber through second exit port 25, whereas analyte that migrates toward electrode 22b can exit the first chamber through first exit port 23. As discussed in more detail below, the rate of analyte migration typically depends on the selected hydrodynamic force generated by bulk fluid flow and the selected electric field strength.

In accordance with another example, a schematic view of a second example of a bulk fluid flow gate is shown in FIG. 2b. The bulk fluid flow gate 10 includes first chamber 12 and an electrode array 14 separated by permeable member 16. First chamber includes a first entry port 20, a second entry port 21, a first exit port 23 and a second exit port 25. In operation, at least in certain examples, bulk fluid flow flows downward from first entry port 20 through chamber 12 exiting first exit port 23. In certain examples, it may be necessary to flow coolant buffer through electrode housing 14, either upwardly or downwardly. Electrode housing 14 includes an electrode array 22. As used herein, the term “electrode array” refers to a plurality of electrodes arranged so as to generate an electric field gradient in the separation chamber. The electric field generated by the electrode array can be DC, AC, or otherwise modulated in time including asymmetric (out of phase) field modulation. The specific nature of the electrode (i.e., size and shape) is not critical. Suitable electrodes include rod-shaped, pin-shaped and staple-shaped electrodes, among others. In one example, the electrode array includes a linear array of electrodes (e.g., 50 electrodes arranged linearly) along an axis parallel to the direction of analyte migration. In addition to arrays having electrodes arranged in line with even spacings from one to the next, suitable arrays also include arrays in which the electrodes are not in line and which are not separated by even spacings. Other configurations of electrodes, including two-dimensional electrode arrays, are also within the scope of the devices and methods. Two-dimensional arrays include arrays having rows and columns of electrodes. The second chamber in certain preferred examples includes more than one electrode array, for example two electrode arrays on opposite sides of the electrode chamber. Suitable electrode array configurations will be readily apparent to the person of ordinary skill in the art, given the benefit of the present disclosure, for example electrode array configurations presented in U.S. Pat. No. 6,277,258, which is incorporated by reference herein in its entirety for all purposes.

In certain examples, each electrode of the array is individually controlled to provide an electric field gradient that can be dynamically controlled (i.e., maintained and adjusted during the course of analyte migration, focusing and/or separation). Control can be manual from the device controller, manually from the device's associated computer, or automatically from the computer once the computer has received feedback from a monitor, such as an optical monitor, for example a video signal, or other suitable monitoring device, following analyte migration or focusing. The controller can sense the electrode's voltage and reset its voltage to its initial setting. Such monitoring allows for computer detection of various peaks, optimization of the separation by locally adjusting the field gradient to tease separated peaks apart, and then pull off those peaks that were selected by the operator either before or during a separation. Suitable configurations of the electrodes, controls, computer equipment and the like will be readily apparent to those of ordinary skill in the art, given the benefit of the present disclosure, for example configurations presented in U.S. Pat. No. 6,277,258, which as noted above is incorporated by reference herein in its entirety for all purposes.

In accordance with other examples, the electronically generated field can take on arbitrary shapes including logarithmic profiles, exponential profiles, profiles taking shape after applying one or more apodization function to the electric field, steps, and even locally reversed gradients, for example, to elute proteins. The field shape can be monitored and maintained by computer and modified “on-the-fly” on a point-by-point basis, both spatially and temporally. During a run the operator can optimize the local properties of the field to sharpen an individual band, move a band to an exit or offtake port or set up a moving gradient to elute one or more bands from the chamber. With online monitoring, for example optical monitoring such as UVNisible monitoring, or potentiometric monitoring, in place, the operator could be replaced by a computer programmed to detect focused peaks and automatically adjust the field shape to optimize the separation and, when necessary, offload products. Suitable monitoring systems and configurations will be readily apparent to the person of ordinary skill in the art, given the benefit of the present disclosure.

As discussed above, in certain examples, the first chamber and the electrode housing in certain examples are separated by a permeable material. Suitable permeable materials, for example, allow ions to pass through the permeable material while (1) desired analytes, for example, macromolecules such as biomacromolecules, are retained in the first chamber; while (2) undesired contaminants can flow, or be dialyzed, out of the first chamber; and (3) desired molecules, for example, buffer ions, can flow, or be dialyzed, into the first chamber. In certain examples, the permeable membrane is conductive to heat and buffer ions but not to bulk fluid flow. The permeable membrane advantageously serves to isolate the electrodes from the first chamber to avoid disruption of bulk fluid flow by gas generation or denaturation of charged analyte by contact with the electrodes. Suitable permeable materials include permeable membranes such as dialysis membranes and ion-exchange membranes. Other suitable permeable materials will be readily apparent to the person of ordinary skill in the art, given the benefit of the present disclosure.

In certain examples, as discussed above, the electrode housing is non-uniform. As used herein, “non-uniform” refers to a housing or chamber that has a non-uniform cross-section, that is to say, the cross-sectional area of the chamber varies axially along the length of the chamber, length referring to the direction in which fluid flows through the separation chamber. In examples using a non-uniform electrode housing, the electrode housing has a cross-section that varies axially along the length of the housing. The electrodes may be operative to generate an electric field in the electrode housing, where the non-uniformity of the electrode housing induces a gradient in the electric field. This electric field gradient is communicated to the first chamber by the porous membrane. The electrode housing in certain examples is substantially uniform, that is, has a uniform cross-section flow channel. The electrode chamber in certain examples has a substantially uniform depth (depth here meaning the direction normal to the plane of the membrane) and a non-uniform or non-constant width (width here meaning the direction perpendicular to the overall direction of flow and parallel to the plane of the membrane). In other examples, the electrode housing has a substantially uniform width and a varying or non-uniform depth. Still other examples employ an electrode housing of non-uniform width and non-uniform depth. Other examples include an electrode housing defined by one or more non-linear walls, for example, a series of faces or facets, some or all having non-uniform dimensions; or wherein the electrode chamber has a curved cross-section, such as, for example, a half-circular cross-section, that varies axially, as, for example, a half-cone-shaped housing with either straight or curved walls in the axial direction. Other suitable non-uniform electrode housing configurations will be readily apparent to those of skill in the art, given the benefit of the present disclosure.

In some examples, devices disclosed here are useful in migration, focusing and separation of charged analytes. In certain examples, the migrating analytes can be eluted from the device through either the first or second exit ports, or other ports positioned suitably along the first chamber, e.g. one or more sampling ports positioned upstream or downstream of bulk fluid flow.

Analytes can be eluted from the first chamber by electric field, pressure, vacuum, or other motive force or may elute as bulk fluid exits the first chamber.

Certain examples of the devices disclosed here can further include a monitoring feature which detects analyte migration. Suitable analyte detection includes optical and potentiometric methods. Optical methods include providing a clear window in the first chamber so that an operator can observe the focusing of the bands directly, and further include optical methods such as UV/Visible spectroscopy that can be monitored by the operator or by computer. Optional integration of the signal put forth from the monitoring feature with software allows automation and computer optimization of analyte loading, separation, and elution steps.

In other examples, the device can be operated in a continuous mode in which analyte for focusing and/or separation is continuously loaded into the first chamber and focused to sampling ports, or allowed to migrate to exit ports, where the analytes are continuously eluted. In the alternative, the device can be operated in a batch mode in which the analyte is loaded in its entirety and then allowed to migrate to one or more exit ports and/or sampling ports.

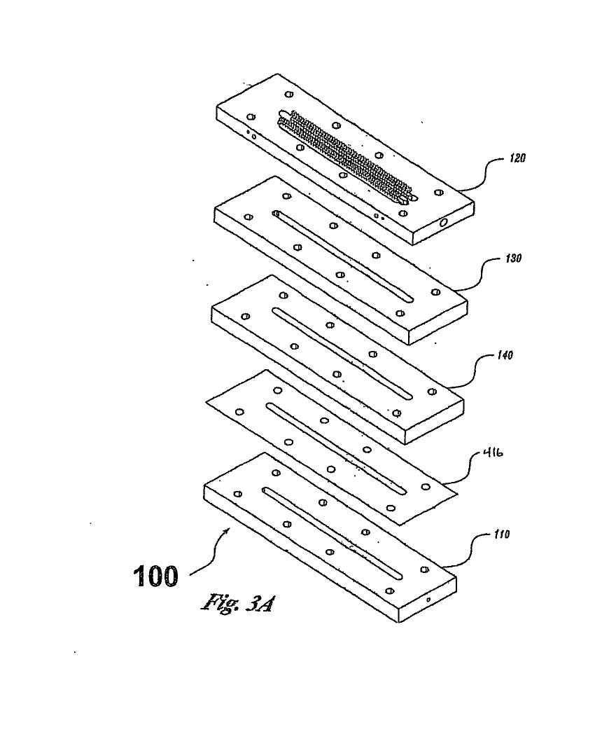

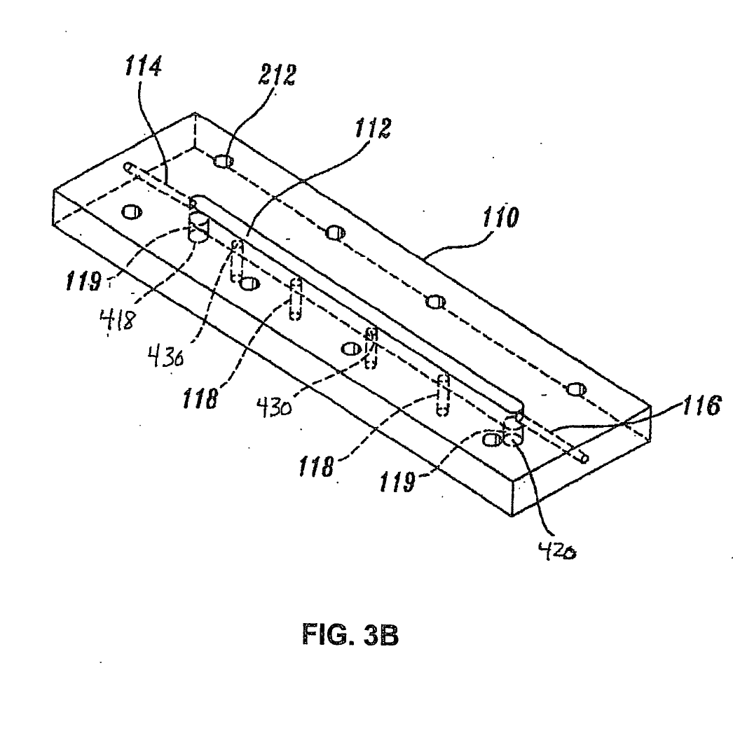

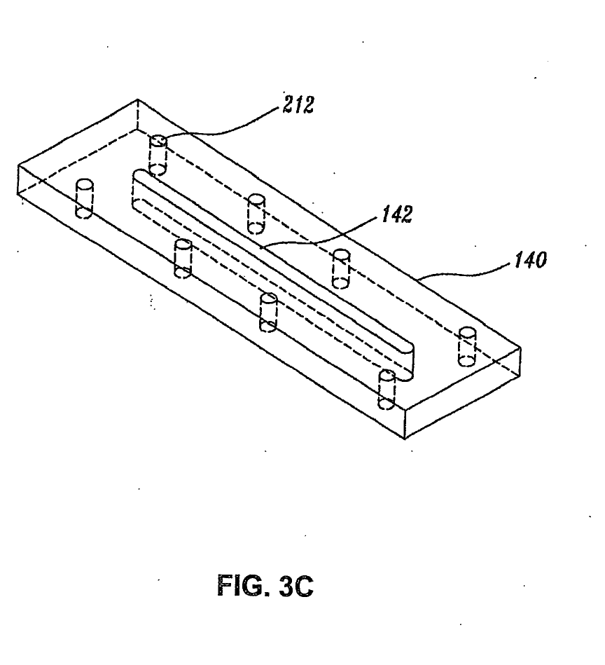

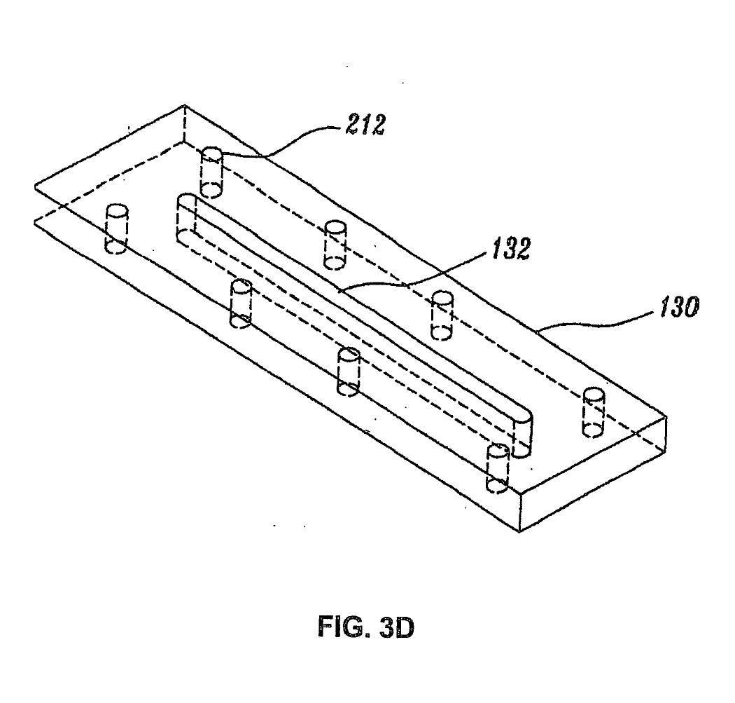

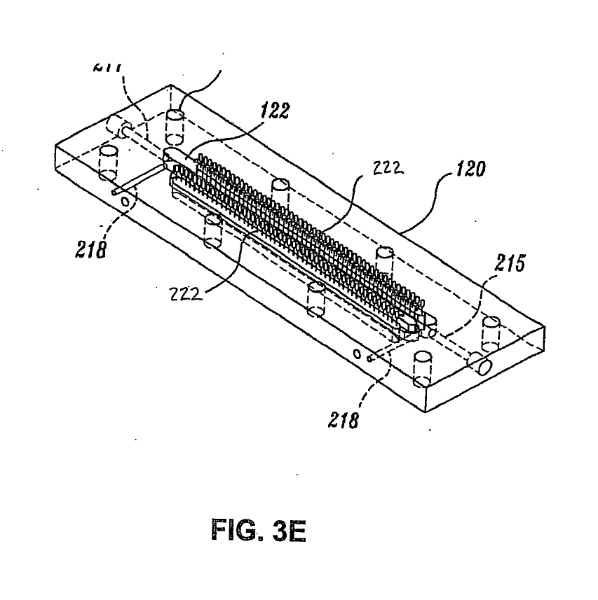

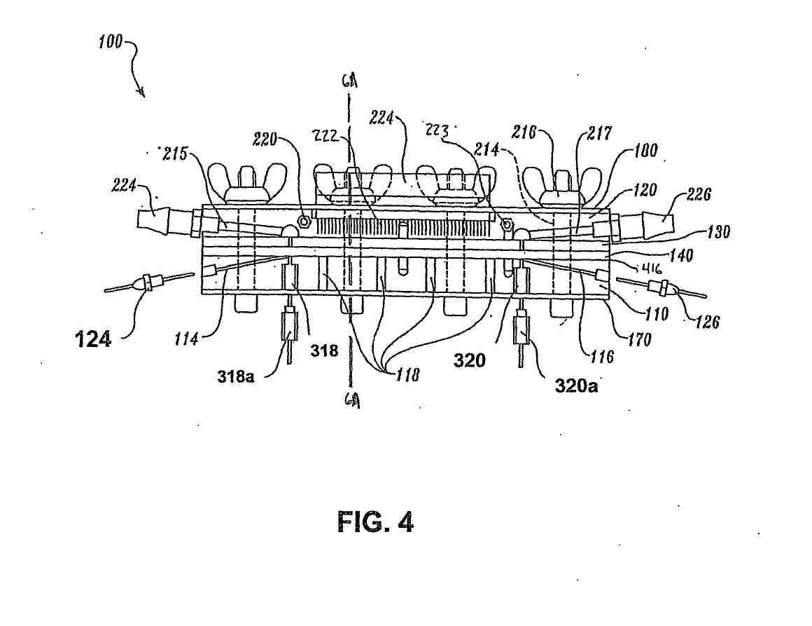

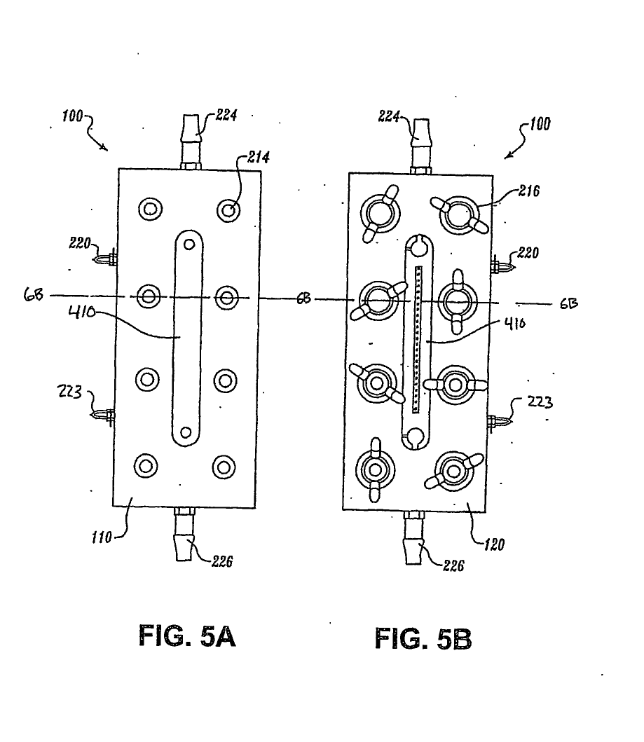

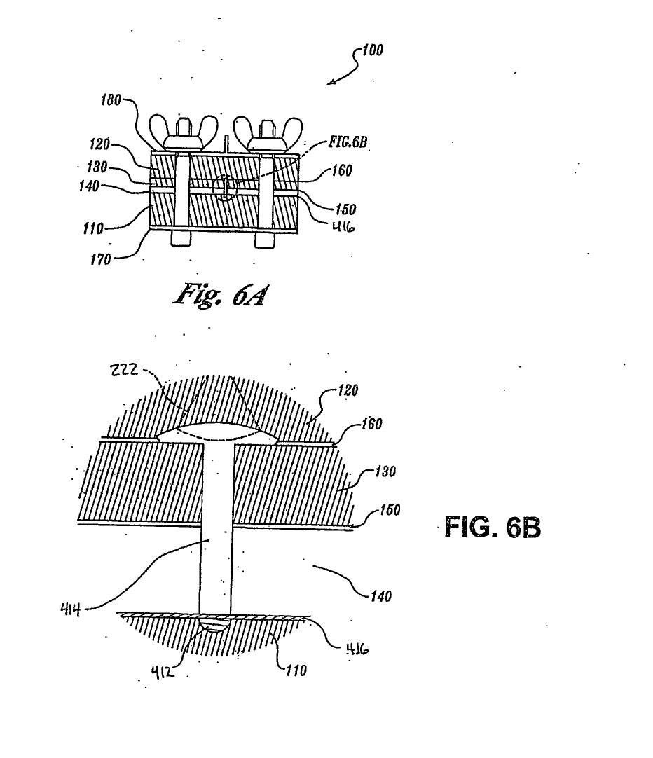

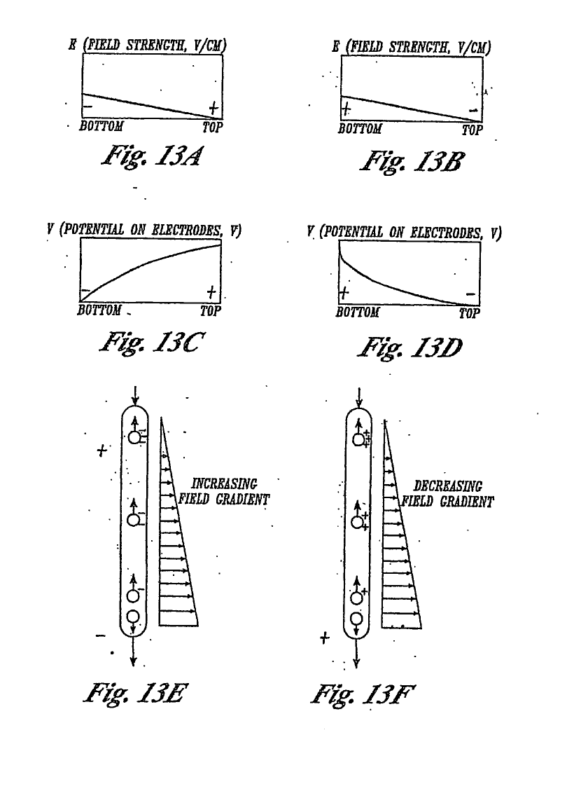

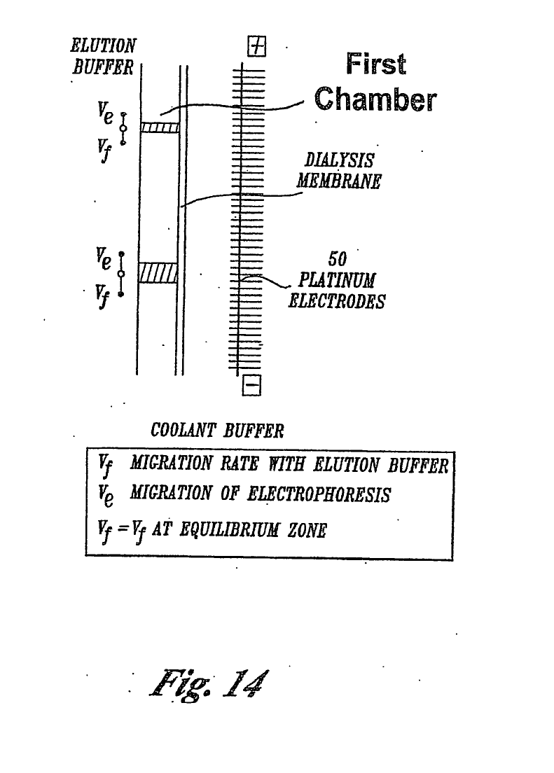

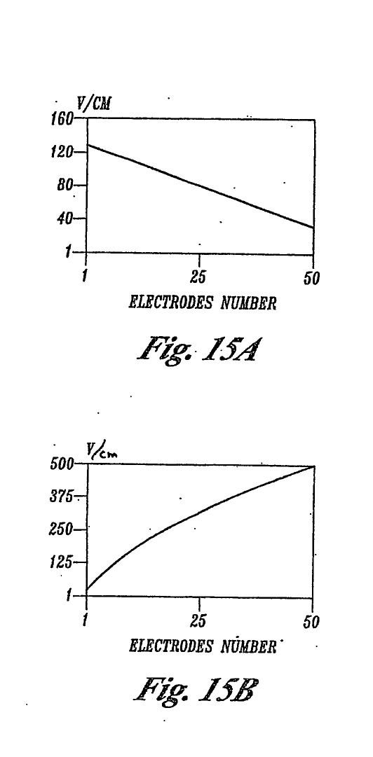

Another example of a bulk fluid flow gate as described above is shown in FIGS. 3-6. FIG. 3 shows an exploded view of the device including front and rear portions. An elevation view of the device is shown in FIG. 4, and forward and rear plan views of the device as illustrated in FIGS. 5A and 5B, respectively. A cross-sectional view of a portion of a representative device illustrating the first chamber, permeable membrane, and electrode housing is shown in FIG. 6.

A representative bulk fluid flow gate including a first chamber is shown in FIG. 3. The example illustrated in FIG. 3 includes side-by-side electrode arrays. Referring to FIG. 3, device 100 has basic components including first block 110 and second block 120 separated by intermediate sheets 130 and 140. Permeable member 416 is intermediate block 110 and sheet 140. Blocks 110 and 120 and intermediate sheets 130 and 140 are formed from machinable materials. Preferably, blocks 110 and 120 and intermediate sheet 130 are formed from PLEXIGLAS and sheet 140 is formed from TEFLON. In one example, each component includes a plurality of apertures 212 that are coincident with the apertures of the other components when the components are assembled. Apertures 212 receive bolts 214 (see FIG. 4) for securing the assembled components and assist in sealing the assembly. As shown in FIG. 4, the components are secured through tightening nuts 216 on bolts 214.

In certain examples, to form the bulk fluid flow gate, first block 110 and second block 120 include troughs 112 and 122, respectively. Trough 122 includes the electrode arrays, each array comprising a plurality of electrodes 222. In other examples, trough 122 may include a single electrode or a pair of electrodes. Sheets 130 and 140 include apertures 132 and 142, respectively. When the components are assembled, troughs 112 and 122 and apertures 132 and 142 are coincident and form a portion of the bulk fluid flow gate 410. Intermediate sheet 140 and block 110 is permeable member 416 which divides bulk fluid flow gate 410 into first chamber 412 and electrode housing 414.

First block 110 includes conduits 114 and 116 which terminate in opposing ends of trough 112. Conduits 114 and 116 serve as the first exit port and the second exit port. First block 110 further includes channel 430 which terminates in trough 112 and which provides for introduction of bulk fluid into the device. Channel 436 also terminates in trough 112 and provides for introduction of sample into the first chamber. Other channels, e.g., channels 118 and 119, may be present for sampling. Channels 118 and 119 also terminate in trough 112 and provide for removal and/or introduction of in the first chamber. Second block 120 includes conduits 215 and 217, which terminate in opposing ends of trough 122. These conduits serve to introduce and exit liquid flow (e.g., coolant) through the electrode housing. In examples of the device that include an electrode pair in addition to the electrode array, second block 120 further includes channels 218 which terminate in trough 122. Channels 218 receive electrodes 220 and 223, which like the electrode array, are in electrical communication with liquid in the electrode housing when the device is in operation.

An examples of an assembled device is illustrated in FIGS. 4 and 5. Referring to FIG. 4, device 100 includes blocks 110 and 120 and sheets 130 and 140, and permeable member 16. First entry port 320 includes adapter 320a, e.g., a connecting device. Second entry port 318 also includes an adapter 318a. First exit port 114 is positioned upstream of first entry port 320. Second exit port 116 is positioned downstream from first entry port 320. Optional sampling ports 118 are also shown. Connector 224 leads to the device's controller and provides current to the electrode(s) or the electrode array. The representative device further includes first and second plates 170 and 180, respectively, which overlie the outward surfaces of blocks 110 and 120, respectively. Plates 170 and 180 can reinforce the assembly. Plates 170 and 180 are preferably steel plates. The bulk fluid flow gate shown in FIG. 4 generally comprises a laminate structure. Suitable laminate structures, and methods for making such laminate structures, are disclosed in the commonly assigned published PCT applications incorporated by referenced above.

FIGS. 6A and 6B are cross-sectional views of a portion of the representative device described above, taken through line 6A-6A in FIG. 4 and through line 6B-6B in FIG. 5. Referring to FIG. 6B, device 100 includes blocks 110 and 120 and sheets 130 and 140. Intermediate block 110 and sheet 140 is permeable material 416 which divides the bulk fluid flow gate into first chamber 412 and electrode housing 414. Sheet 140 serves as a spacer for adjusting the depth of electrode housing 414 and, the thickness of sheet 140 can be varied as desired. Sheet 140 is a resilient sheet and also serves to seal block 110 to the remaining components of the assembly. Intermediate sheet 140 and sheet 130 is a sealant layer 150. Sealant layer 150 includes a sealant that effectively joins sheet 140 to sheet 130 and prevents fluid from escaping the electrode housing. Intermediate block 120 and sheet 130 is adhesive layer 160. Adhesive layer 160 includes an adhesive that effectively joins sheet 130 to block 120.

A representative device including a bulk fluid flow gate is formed from two blocks of 15×6×1.2 cm³ PLEXIGLAS and a 0.3 cm thick TEFLON spacer. The front block, which houses the first chamber has a trough 8×0.1×0.05 cm³ machined into it, the rear block, which houses 50 controllable electrodes, has a trough 6.4×0.3×1.5 cm³, and the spacer has a 6.5×0.2 cm² slot machined through it. The trough in the front block is isolated from the spacer by the permeable material. The rear trough and slot admit a recirculating buffer, e.g., coolant, that can have the same composition as the bulk fluid or may be different. Because the coolant is in contact with the separation column by a permeable material, the coolant can also be used to dialyze the running buffer to exchange salts or other low molecular weight analytes. The coolant inlet and outlet are shown in FIGS. 4 and 5.

Cooling of the electrode chamber and/or of the device overall can be provided by any suitable heat removal system. Exemplary systems include flows of cooling fluid, in the electrode chamber, thermoelectric coolers, refrigeration systems relying upon the evaporation of a refrigerant fluid (typically then recirculated through a condenser, etc.), etc. In accordance with certain exemplary embodiments a coolant buffer is employed. Outside of the electrode housing, the coolant buffer can be circulated through a glass heat-exchange reservoir submerged in an ice bath. From here the coolant is introduced into the bottom of the bulk fluid flow device and is passed over the electrodes. In micro-scale and certain larger embodiments of the devises and methods disclosed here, such flow can be at rate of about 500 mL/min to 1500 mL/min, e.g., about 900 mL/min. Flow can be controlled using, e.g., a centrifugal pump (Cole-Parmer) or other suitable pumps and devices, e.g., peristaltic pumps and the like. In micro-scale and certain larger embodiments of the devises and methods disclosed here, a syringe pump typically controls the flow of bulk fluid through the chamber. In micro-scale embodiments of the devises and methods disclosed here, exemplary flow rates are 0-20 microliters per minute. In micro-bore scale embodiments of the devises and methods disclosed here, exemplary flow rates are 20-100 microliters per minute. In analytical scale embodiments of the devises and methods disclosed here, exemplary flow rates are 1.0 mL/min. to 2.0 mL/min. In preparative scale embodiments of the devises and methods disclosed here, exemplary flow rates are 2.0 to 20.0 mL/min. In process scale embodiments of the devises and methods disclosed here, exemplary flow rates are 20 mL/min and higher. The bulk fluid enters the first chamber through first entry port and exits the first chamber thorough first exit port. In certain examples, all lines are PEEK with flangeless fittings; sample can be loaded through a 10-μL loop on a six-port injection valve (Upchurch) which is in fluid communication with the second entry port.

In certain examples, the electrodes can be made from 0.25-mm-o.d. platinum wire (Aldrich Chemical), mounted in the rear PLEXIGLAS block with a 0.05-in. pitch, and are connected to a SCSI ribbon cable, or other suitable cables such as IDE cables, USB cables, IEEE1394 cables, SATA cables, etc., using SMS-series microstrips (Samtec). Each of the SCSI leads is connected to its own printed-circuit (PC) monitor/controller board mounted on the wire wrap motherboard. Each monitor/controller board is segregated into three areas: high voltage, monitoring, and control. The high-voltage area isolates the electrode voltages, which can be as high as 600 V, from the relatively sensitive electronics used to measure and adjust the electrode voltages. The monitor area of each PC board scales down the electrode voltage by about 100× and sends this signal to a commercial thermocouple board which digitizes the signal before sending it to the computer. The computer scans all 50 electrodes, compares these readings with the programmed profile, and sends a digital signal to a set of 50 DACs which tell the optical isolators to adjust the effective resistance of high-voltage line to reduce the departure of the measured electrode voltages from the programmed voltage profile. A complete scan/control cycle of the 50 controllers is taken every second. Each of the 50 controllers is mounted vertically on a wire-wrapped motherboard; power to the controllers' motherboard is drawn from the computer. A 600-V power supply (Xantrex) provides current to the column's 50 high-voltage electrodes via the 50 voltage controllers.

In certain examples, the device is operated as follows. After the recirculating coolant has reached operating temperature and the first chamber has been cleaned, e.g., with 7 M urea, and equilibrated with bulk fluid, a suitable amount of sample, e.g., 10 μL, is injected into the chamber using a standard sample loop in communication with second entry port. Before sample reaches the first chamber, the controller is booted using a default voltage pattern and the power supply is brought up to a voltage in the range 200-600 V. The operator then selects the initial electric field or electric field gradient, and the computer program adjusts the electrode voltages until this gradient is attained, typically less than 5 min. from a “cold” start. Where the electrophoretic mobilities or charge to mass ratios of two analytes are sufficiently close, the electric field gradient alone may be insufficient to separate them. Without wishing to be bound to any particular scientific theory, it is currently understood that analytes are separated by the methods and devices disclosed here on the basis of their molecular weights by effectively applying different hydrodynamic forces to differently sized molecules; that is to say, due to bulk fluid flow and/or changes in the volume and velocity of bulk fluid flow.

Although the above examples illustrate the use of linear electric field gradients, the software can be modified to allow point-by-point adjustment of the field including reversing the field to aid in migration or elution of fractionated bands, isolating and mobilizing a single protein band, or stepping the gradient to improve processing capacity. In addition, because the electronic controller and the technique are largely independent of chamber capacity, there is no reason it cannot be applied at larger or smaller scales.

Certain examples of the bulk fluid flow gate provided by the methods and devices disclosed here optionally rely in part on field gradient control, which includes hardware and software. Representative gradient control hardware and software are discussed below.

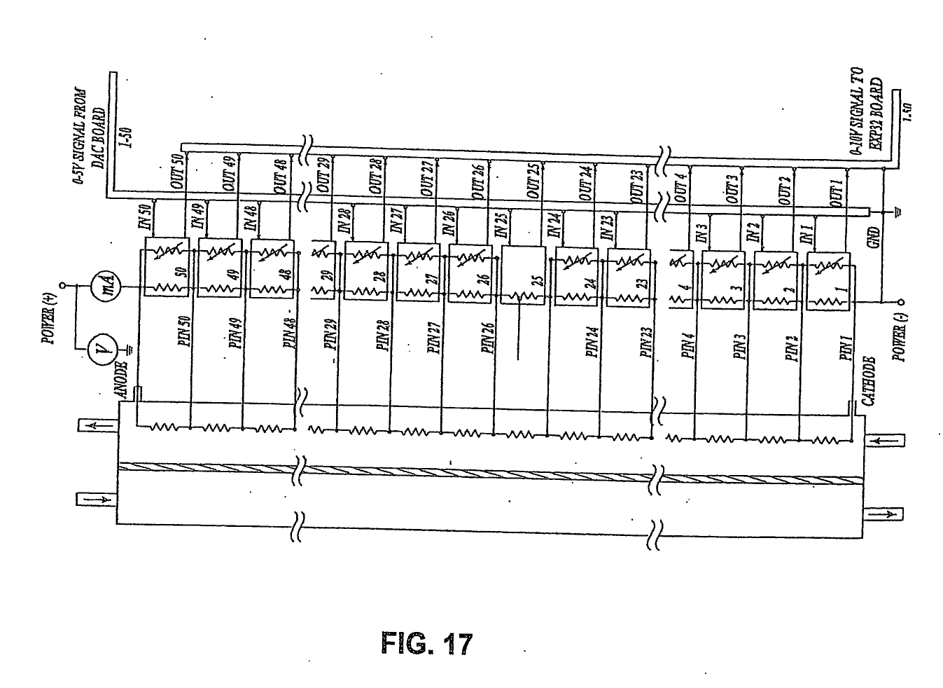

The control circuits are designed to manipulate the field gradient by adjusting the effective electrical resistance between two adjacent electrodes (see FIG. 16). In one example, each pair of electrodes is connected to one of the 50 controller units. A schematic of such an example is shown in FIG. 17, in which the blocks with dash line frames are controller units and each of the controller units handles the data acquisition and the resistance control of two adjacent electrodes.

The electrical resistance between two adjacent electrodes Rᵢ is determined by the sum of the resistance of three parallel resistors, Rcᵢ, Rpᵢ, and Rxᵢ. Note that the buffer between electrodes is considered as a resistor Rcᵢ.

$${R}_{i} = \frac{{Rc}_{i} \cdot {Rp}_{i} \cdot {Rx}_{i}}{{Rc}_{i} \cdot {Rp}_{i} + {Rc}_{i} \cdot {Rx}_{i} + {Rp}_{i} \cdot {Rx}_{i}} \qquad ( 1 )$$

The resistors Rpᵢ are used for protective purpose and have 1 MΩ resistance. Because Rₚ>>Rcᵢ, Rₚ>>Rxᵢ. Equation (1) can be simplified as

$${R}_{i} = \frac{{Rc}_{i} \cdot {Rx}_{i}}{{Rc}_{i} + {Rx}_{i}} \qquad ( 2 )$$

By changing each Rxᵢ, the circuits adjust each Rᵢ indirectly. In accordance with Ohms Law, the potential drop between two electrodes is determined by the resistance between them when the total current is constant. The potential drop between the two adjacent electrodes is given by

$${V}_{i} = {V}_{total} \cdot \frac{{R}_{i}}{{\sum }_{i}^{50} {R}_{i}} \qquad ( 3 )$$

Since the field strength is proportional to the potential drop with the electrodes equally spaced, the field strength point by point can be manipulated by adjusting each Rxi, independently.

$${E}_{i} = \frac{{V}_{i}}{d} = \frac{{V}_{total}}{d} \cdot \frac{{R}_{i}}{{\sum }_{i}^{50} {R}_{i}} \qquad ( 4 )$$

where d is the distance between the two adjacent electrodes. An electric field gradient in any shape, linear or nonlinear, continuous or stepwise, can be produced with a limitation to the conductivity of the buffer. Note that the resistance between two parallel-connected resistors is always less than any one of them, in other words, Rᵢ<Rcᵢ must be satisfied.

The person of ordinary skill in the art, given the benefit of this disclosure, will recognize that there is more than one group of Rᵢ that satisfies Equation 4. In other words, different groups of Rxᵢ can be used to establish the same field gradient with the total current going through the chamber arbitrarily. There is no unique equilibrium state.

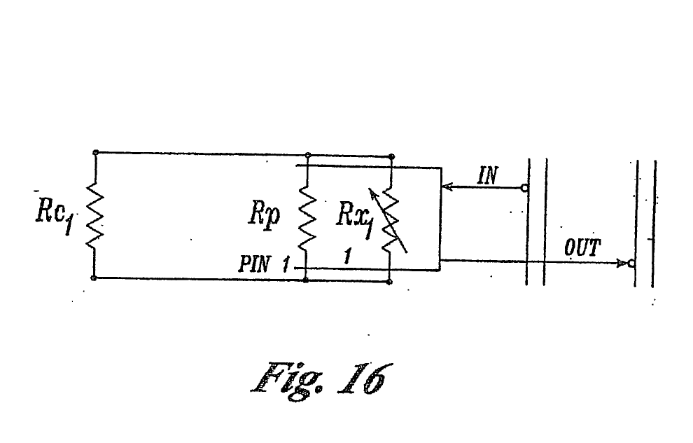

In certain examples, dynamic electric field gradients are created by a computer-controlled external circuit, which manipulates the field strength between each pair of adjacent electrodes, as exemplified in FIG. 14. Varying field strength along the first chamber can thus be achieved. FIGS. 15A and 15B are graphical representations of linear electric field gradients so generated.

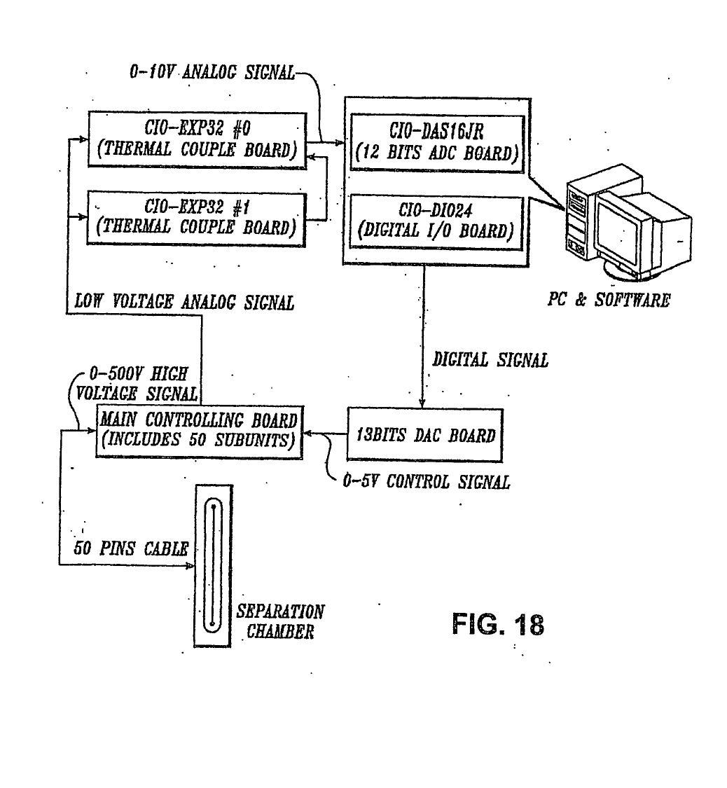

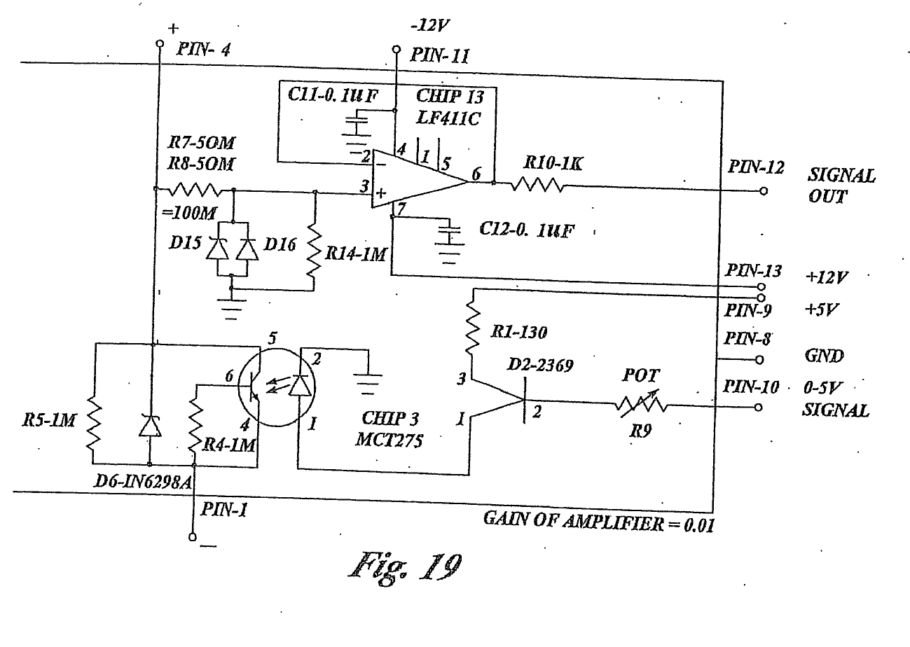

Representative gradient control circuits are shown schematically in FIG. 18.

The blocks represent electronic boards, the lines represent standard ribbon cables, e.g., IDE cables, USB cables, IEEE1392 cables, serial cables, parallel cables, SATA cables, SCSI cables and the like. Referring to FIG. 18, the PC monitor/controller board and the 13-bit DAC board were built in our laboratory. Some modifications have been made for better performance. The data channels between the two CIO-EXP32 boards and the CIO-DAS16Jr boards are programmed rather than being physically connected. CIO-DAS16Jr and CIO-DIO24 are plugged into extension slots of the PC. The two thermocouple boards CIO-EXP32, the 16-channel ADC board CIO-DAS16/Jr and the 24-channel Digital I/O board CIO-DIO24 were purchased from ComputerBoards, Inc. Standard SCSI ribbon cables are used to connect all the boards. There are 50 controller units plugged into the mother board. Each unit corresponds to one pair of electrodes. The whole system was grounded to protect the circuits from unexpected shock.

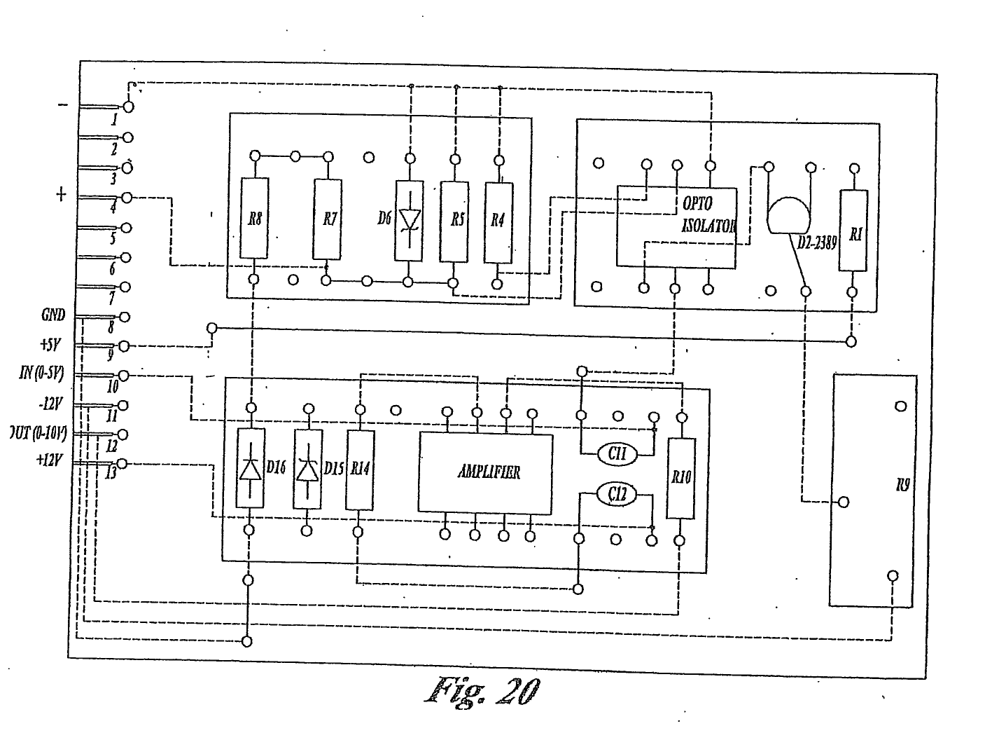

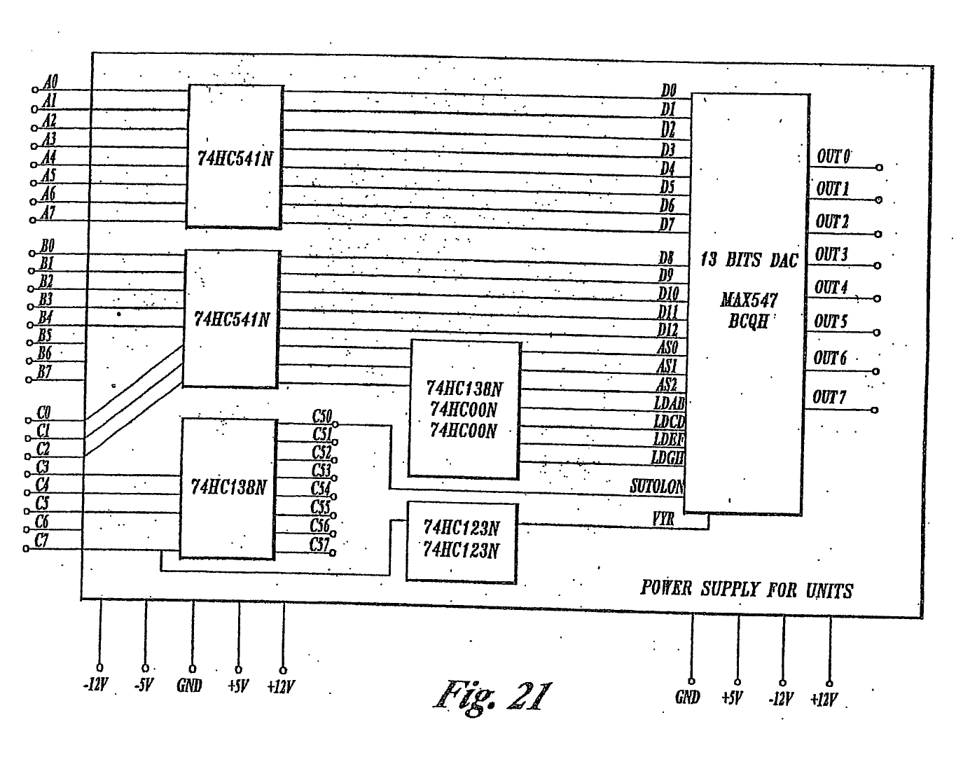

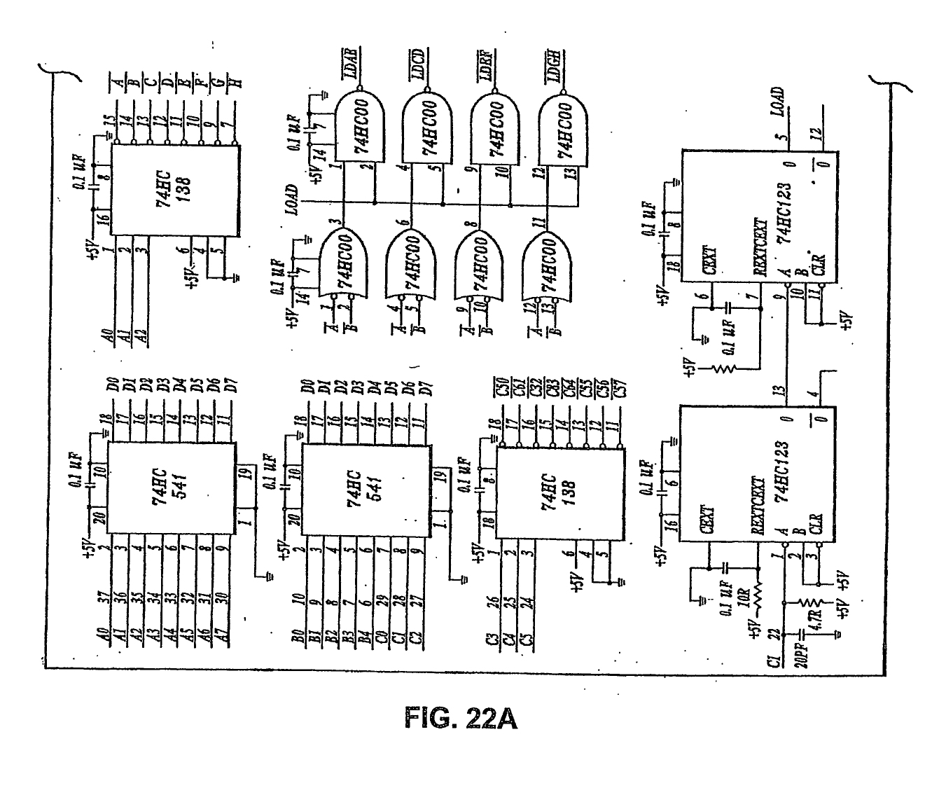

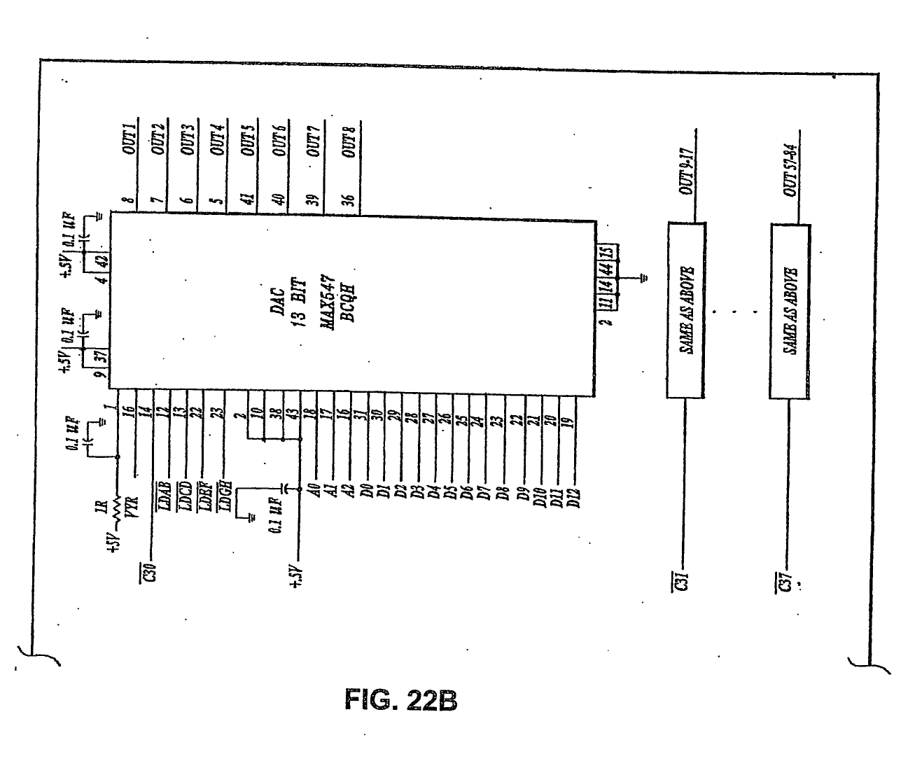

The gradient control is accomplished with PC-controlled circuits, diagrammed in FIG. 19, which are composed of electronic circuit boards. Pin 1 and 4 are connected to electrodes and neighboring units. The electrical potential on the electrode is reduced by 1/100, then enters amplifier LF411C where the load of the signal is increased. The signal is then sent to EXP32 board through pin 12, and the control signal (pin 10, 0-5 V) from the DAC board adjusts the current going through the optical isolator MCT275. A circuit diagram of the controller unit is shown in FIG. 20. A logic diagram for circuit diagram for ADC board is shown in FIG. 21. A circuit diagram for the ADC board with components identified is shown in FIG. 22.

The circuits scan all 50 electrodes and scale the signals down by 1/100. Then the signals are sent to ADC board where 0-10V analog signals are digitized. The computer compares these readings with the programmed gradient, then sends its commands in digital signals to DAC board via the Digital I/O boards. In the DAC board, the command signals are converted to 0-5V analog signals, then sent to the 50 units on the PC monitor/controller board. Those units adjust the current going through the units or changes the values of resistance Rxi. Note that the Rxi do not exist physically, and they are the resistance to current going through the chip MCT275, an optically isolated controller. The scan/response cycle for the circuits is set at about 0.5 sec, and could be adjusted by the program.

In some examples a suitable power supply, such as a 600V DC power supply (Xantrex), supplies power to the bulk fluid flow gate. The power to all the boards is typically supplied by the computer's power supply.

As noted above, the electrode housings can include more than one electrode array. For example, two electrode arrays can be associated with the first chamber in a configuration in which the first chamber is positioned in between the two arrays. Similarly, the first chamber can include, for example, four electrode arrays positioned about the first chamber in a quadrupole-type configuration. Representative devices including one, two, and four electrode arrays are illustrated schematically in FIGS. 25A-C. Referring to FIG. 25, representative device 10 including a single electrode array (i.e., located in electrode housing 14) and a first chamber (i.e., chamber 12) is shown in FIG. 25A. FIGS. 25B and 25C illustrate representative devices 610 and 710 having two and four electrode arrays and electrode chambers 614 and 714 arranged about separation chamber 612 and 712, respectively.

In accordance with certain examples, solvents that are used in the devices and methods disclosed here can be degassed prior to introduction into the bulk fluid flow gate. Without wishing to be bound by any particular scientific theory, it is believed that dissolved gases in the fluids can affect the reproducibility of the flow rates of the fluids. To achieve constant and reproducible flow rates, it may be necessary to remove at least some of the dissolved gases from any solvents prior to introduction of the solvents into the devices described here. The person of ordinary skill in the art, given the benefit of this disclosure, will be able to select suitable techniques for degassing the solvents including, but not limited to, vacuum filtration of the solvents, e.g., filtration through a fritted funnel, bubbling of inert gases, such as, for example, argon and nitrogen, through the solvents, and the like.

In accordance with some examples, a solvent gradient can be used such that the composition of the bulk fluid is altered during migration of the analytes in the sample. As used here, solvent gradient refers to variation in the composition of the bulk fluid during migration of analyte and/or separation of the analytes. For example, in a separation using bulk fluid comprising two solvents, A and B, the separation may begin with 100% solvent A as bulk fluid. As the separation progresses, the amount of solvent B can be increased, e.g., linearly, step-wise, logarithmically, etc., such that the composition of the bulk fluid introduced into the first chamber includes both A and B. Typically, the amount of each solvent in the solvent gradient is controlled by varying the amount of solvent introduced into the first chamber. In certain examples, it may be necessary to provide a mixing chamber so that the solvent can be mixed prior to introduction of the solvents into the devices described here. In other examples, the solvent gradients are computer controlled to provide high precision for the separations. One skilled in the art, given the benefit of this disclosure, will be able to select suitable solvent gradients for use in the devices and methods disclosed here.

In accordance with certain examples, lipids may be introduced either in the bulk fluid or in the loaded sample. Without wishing to be bound by any particular scientific theory, lipids typically are either hydrophobic, having only nonpolar groups, or can be amphipathic, having both polar and nonpolar groups. In embodiments where one or more analytes is uncharged, it may be necessary to introduce an amphipathic lipid into the sample. Again without wishing to be bound by any particular scientific theory, the nonpolar group of the lipid can associate with one or more uncharged analytes, e.g., through hydrophobic interactions, hydrogen bonding, dipolar interactions, and the like, while the polar group of the lipid remains free to provide an overall charge to the lipid-analyte complex. In certain embodiments, lipids are selected from phosphatidic acid, phospholipids and glycerophospholipids such as, for example, phosphatidylcholine, phosphatidylethanolamine, phosphatidylserine, cardiolipin, phosphatidylglycerol, phosphatidylinositol, and the like. In other embodiments, the lipids may include ether glycerophospholipids, cerebrosides, sphingolipids, and the like. One skilled in the art, given the benefit of this disclosure, will be able to select suitable lipids for use in the devices and methods disclosed here.

In accordance with other examples, the lipids can form micelles that may associate with one or more analytes. Without wishing to be bound by any particular scientific theory, because the amphipathic lipids typically include a nonpolar group and a polar group, when the lipids are placed into an aqueous solvent, the lipids typically spontaneously associate with each other such that the polar groups are positioned outward towards the aqueous solvent and the nonpolar groups are positioned inward away from the aqueous solvent. Typically, it is necessary to provide the lipids in a sufficient amount, e.g. a critical micelle concentration (CMC), such that micelles can spontaneously form. That is, when the lipids are present at concentration below the CMC, the predominate form is individual free lipids. When the lipids are present at a concentration greater than or equal to the CMC, the predominant form is micelles. Suitable CMC concentrations will be readily selected by those skilled in the art, given the benefit of this disclosure, and the CMC concentration typically depends on the type of lipid selected.

In accordance with some examples, the lipids may form vesicles, e.g., unilamellar (large unilamellar vesicles (LUVs), small unilamellar vesicles (SUVs)) or multilamellar vesicles. Such vesicles are typically characterized as including one or more bilayers formed when the nonpolar groups of the lipids associate with each other. Suitable methods for preparing vesicles will be readily selected by those skilled in the art, given the benefit of this disclosure, and include but are not limited to extrusion, sonication/extrusion, and the like.

In accordance with certain examples, when the device of FIG. 2a is used to purify a sample or separate analytes in a sample, sample is introduced into first chamber 12 through second entry port 21. Bulk fluid flows substantially downward towards first exit port 23. The charge of the electrodes is selected such that at least some of the analytes in the sample will migrate upstream towards second exit port 25. The velocity and volume of bulk fluid is selected such that the analyte migrates with a suitable migration rate. In examples employing a substantially constant electric field, the velocity and/or volume of bulk fluid introduced into first chamber 12 can be increased such that hydrodynamic resistance is substantially greater than the driving force provided by the electric field. In such cases, substantially all of the analyte will migrate towards first exit port 23. Depending on the selected strength of the electric field and the selected hydrodynamic force from bulk fluid, the migration rate and migration direction of analyte may be controlled.

In the device shown in FIG. 2a, because bulk fluid flows substantially downstream towards first exit port 23, hydrodynamic resistance at first exit port 23 is substantially greater than hydrodynamic resistance at second exit port 25. A result of such differential hydrodynamic resistance is that once the analyte migrates upstream of first entry port 20, the rate of migration depends more on the electric field strength and less on the flow of bulk fluid. At points proximate to first entry port 20, a gating effect is observed as analytes approach the portion of first chamber 12 near first entry port 20. Once the analyte clears the first entry port, e.g., once the analyte migrates upstream of first entry port 20, the gating effect of bulk fluid becomes minimal, or in certain examples, the gating effect is non-existent.

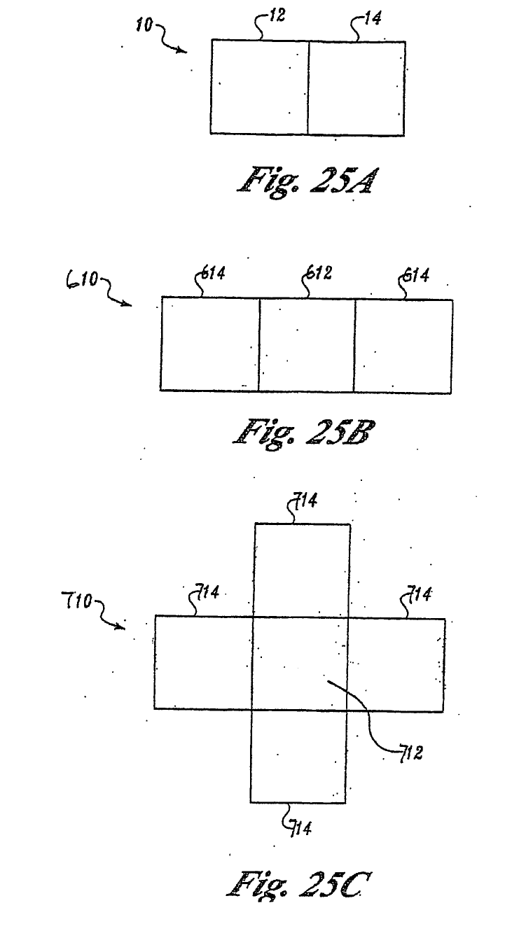

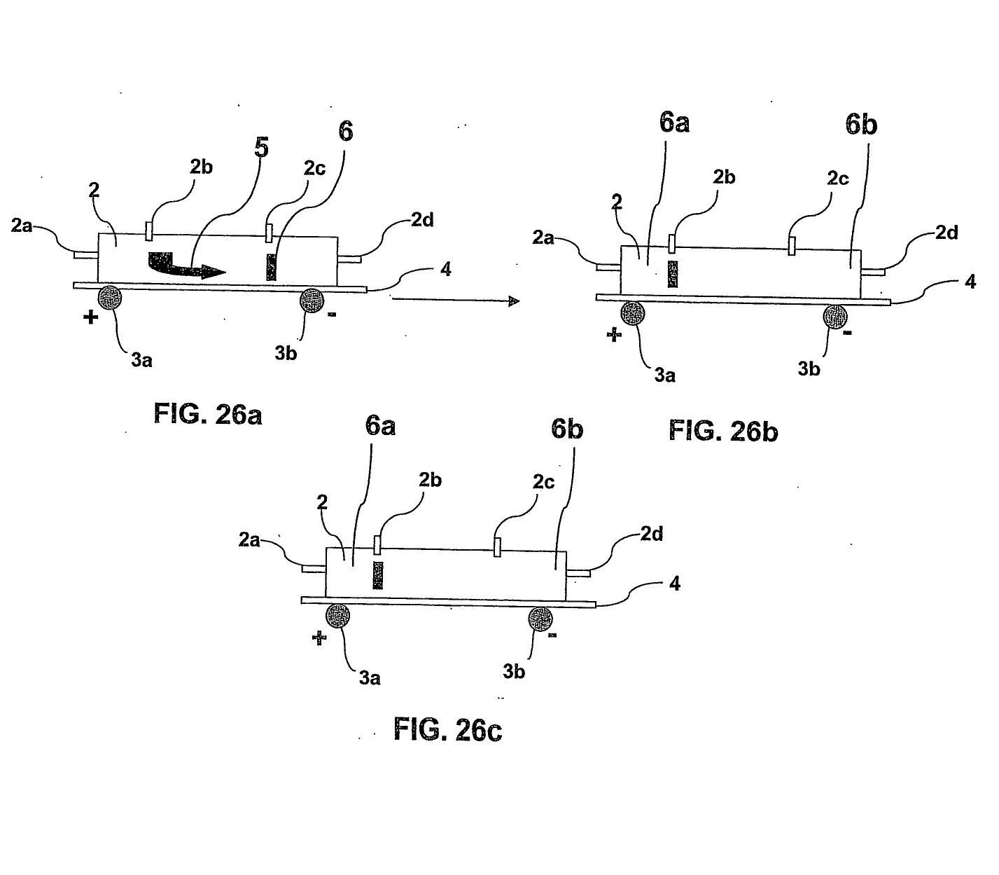

In certain examples and referring to FIG. 26a, during operation of the bulk fluid flow gate, sample 6 is introduced into the first chamber 2 through second entry port 2c. In this example, the sample comprises a single charged analyte that is negatively charged. In the presence of an electric field, the sample will be driven towards positively charged electrode 3a and away from negatively charged electrode 3b.

In certain examples, the hydrodynamic force generated by bulk fluid and the driving force generated by the electric field are selected such that the sample is allowed to migrate towards second entry port 2a Without wishing to be bound by any particular scientific theory, the operating parameters in this example are selected such that upon arrival of the analyte at first entry port 2b, the hydrodynamic force and the driving force of the electric field are approximately equal so that no net migration of analyte 6a occurs (see FIG. 26b). Impurities in the sample are allowed to migrate and exit the first chamber either through first exit port 2d or second exit port 2a. After exiting of impurities, the analyte can exit through the second exit port by increasing the electric field strength and/or reducing the hydrodynamic force generated by bulk fluid flow. In examples where it is desirable to exit the analyte from the first exit port, the hydrodynamic force can be increased or the electric field strength can be decreased so that the sample exits from the first exit port. It will be within the ability of the person of ordinary skill in the art to select suitable hydrodynamic forces and electric field strengths so that the analyte will exit from either the first exit port of the second exit port.

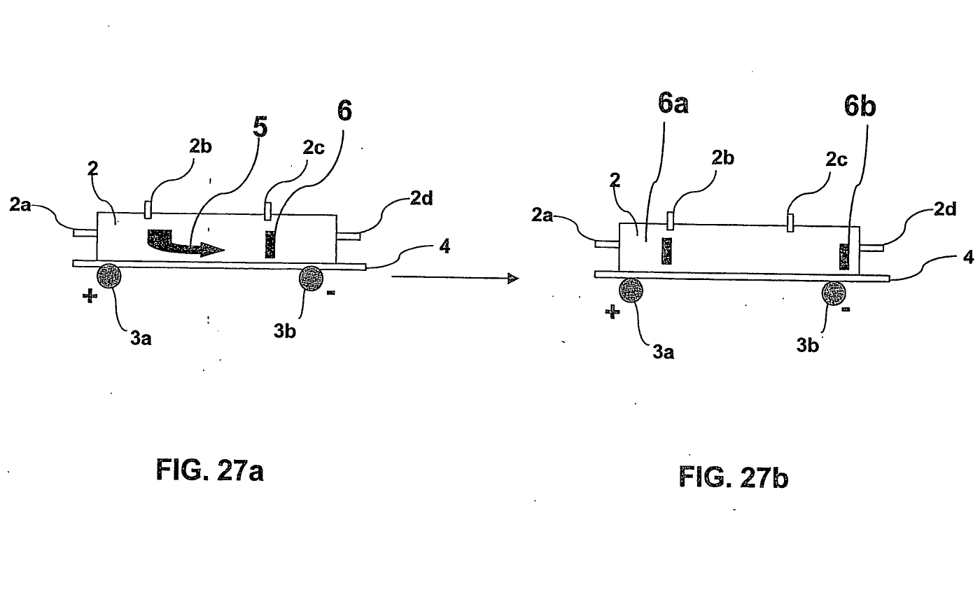

In other examples and referring to FIG. 27a, during operation of the bulk fluid flow gate, sample 6 is introduced through second entry port 2c. In the example shown in FIGS. 27a and 27b, the sample comprises two analytes—one positively charged and one negatively charged. Bulk fluid 5 is flowed into chamber 2 and exits chamber 2 though first exit port 2d, which is downstream of first entry port 2b and second entry port 2c. The analytes typically will migrate towards the electrode having an opposite charge. One analyte of the sample will migrate towards electrode 3a and the other analyte of the sample will migrate towards electrode 3b. Without wishing to be bound by any particular scientific theory, because analyte 6b migrates in the same direction as bulk fluid flow, analyte 6b typically will exit the first chamber, through first exit port 2d, faster than analyte 6a will exit the first chamber. In particular, the driving force of the electric field should exceed the hydrodynamic force generated by bulk fluid flow for analyte 6a so that the analyte can migrate towards second exit port 2a. Depending on the selected hydrodynamic force and selected electric field strength, the migrating analyte can be halted at any portion in the chamber. In certain examples, the hydrodynamic force and electric field strength are selected such that once analyte 6a migrates to a position proximate first entry port 6a, the analyte is held in this position until a user desires to elute the analyte from the chamber through second exit port 2a. In certain examples, the analyte is held proximate to first entry port 2b until substantially all other analyte exits the chamber through first exit port 2a (see FIG. 26c). Then, in certain examples, the hydrodynamic force is increased, or the electric field strength is decreased, and analyte 6a is pushed back downstream of the first entry port and exits through first exit port 2d. In other examples, the hydrodynamic force is decreased and/or the electric field strength is increased and analyte 6a exits the first chamber through second exit port 2a. It will be within the ability of the person of ordinary skill in the art to select suitable hydrodynamic forces and electric field strengths to elute analytes from a desired port.

In some examples, a system is provided comprising the bulk fluid flow gate. The bulk fluid flow gate of the system typically includes at least one electrode for generating an electric field, e.g., an electrode pair or an electrode array, a first chamber in communication with the at least one electrode, the first chamber comprising an first entry port, a first exit port, a second entry port positioned between the first entry port and the first exit port, and a second exit port. The system also typically includes a sample loader such as an injector in communication with the second entry port of the first chamber. The injector provides for the ability to load samples into the system. Suitable injectors will be readily apparent to those skilled in the art, given the benefit of this disclosure and exemplary injectors include loop-injectors, automated liquid handlers, auto-samplers, direct syringe feed and the like. The system also includes one or more detectors for detecting analytes as the analytes exit the first chamber. It is possible to configure the system with innumerable types of detectors. Exemplary detectors include UV/Visible detectors, nuclear magnetic resonance detectors, infrared detectors, fluorescence detectors, electrochemical detectors, and mass spectrometers. Typically the detectors include a flow cell such that analyte exits the first chamber, through either the first or second exit port, and flows into the flow cell of the detector where it is detected. It will be within the ability of those skilled in the art, given the benefit of this disclosure, to select and design suitable systems for separating and detecting one or more analytes in a sample.

In certain examples it may be necessary to degas the bulk fluid to remove any dissolved gases in the bulk fluid to minimize pressure fluctuations in the chamber or to reduce the likelihood of variations in flow rate. Suitable degassing techniques are known to the person of skill in the art and include but are not limited to bubbling of inert gases, such as, for example, nitrogen or argon, through the solvents, filtration of the solvents through a microporous filter, and the like.

In certain examples, flow rate of the bulk fluid is altered or changed during migration of the charged analytes. For example, the flow rate of bulk fluid can be altered throughout the focusing or separation to increase the opposing force, i.e., the hydrodynamic force, against the migrating sample or decrease the opposing force against the migrating sample. In some examples, the flow rate is controlled by a microprocessor such that reproducible flow rates can be used for subsequent separations.

In accordance with certain examples, a given set of focusing process parameters, as noted above, includes all parameters, both dynamic and non-dynamic, that affect the location of an analyte in the first chamber. Such factors include but are not limited to, for example, dynamic factors, or factors that are capable of being changed, such as the particular characteristics such as the shape and strength of the electric field gradient; the composition, concentration and pH of bulk fluid; the flow rate of bulk fluid; the composition, concentration and pH of the coolant fluid flowing through the electrode housing; the flow rate of the coolant; and other such dynamic factors. The parameters that make up the process parameters further include non-dynamic factors such as the dimensions of the first chamber and second chamber; and other such non-dynamic factors.

In some examples, in simultaneous separation in a first chamber of multiple charged analytes having the same or similar charge to mass ratios, the velocity of the bulk fluid and the electric field strength are each chosen such that the location of the stationary focused band of each such analyte is shifted in the chamber to a different degree and preferably there is “baseline” separation between the different analytes such that each analyte may be removed from the chamber substantially free from contamination by other analytes. It should be understood, however, that reference here to each of multiple analytes being shifted to a different degree does not exclude the possibility that in any given stationary focused band there may be more than one analyte, that is, there may be analyte mixtures for which the devices and methods disclosed here are operative to establish focused bands of subsets of the analytes, each subset containing one or more of the analytes.

In certain examples, the bulk fluid may comprise water, a suitable buffer, organic solvents, ion-pairs and the like. Generally, high concentrations of buffer are used to stabilize samples comprising biomolecules, such as proteins, for example. However, as ionic strength of the buffer increases, so does the conductivity of the buffer. Such increases in conductivity can increases the heat generation and power consumption and can set a limit for the highest suitable field strength. Typical field strengths include, for example, 180 to 300 V/cm. In some examples, the same solution is used as bulk fluid and as the solvent which the sample is dissolved in. The fluid in a direction substantially opposite bulk fluid flow and, in certain examples, flows upward in the electrode housing such that any gas bubbles generated at the electrodes are removed from the electrode housing. In addition, the fluid in the electrode housing acts as coolant to remove the heat generated. In certain examples, the fluid of the electrode housing is circulated through a cooling apparatus, such as a cooling bath, heat exchanger, and the like, to remove the heat from the fluid, and the may then be recycled back into the electrode housing.

In certain examples, molecular sieves, other separation media, may be included in the first chamber. The molecular sieves include any medium or substance, for example suitable organic or inorganic polymer or the like, by which shifting of the focusing location is achieved. The molecular sieve is selected for its ability to shift the location of the stationary focused band of analyte for simultaneous focusing of multiple charged analytes. Preferably, a molecular sieve is chosen such that the amount to which the stationary focused bands of analyte are shifted for a given set of focusing conditions varies with the size or molecular weight of the analyte. Preferably the degree of shift varies proportionally with the molecular weight of the analyte, for example, such that each stationary focused band of charged analyte is focused at a stable location separate from the other charged analytes. Factors that affect the selection of a particular molecular sieve at a particular concentration include, for example, the size of the molecules to be separated and focused, the pH at which the system is operated, and other such relevant factors that will be apparent to those skilled in the art, given the benefit of this disclosure. In certain examples, the molecular sieve comprises a gel, which may be either an organic gel or an inorganic gel or a combination of organic and inorganic gel. The gel may be a fixed gel. A fixed gel optionally may be polymerized within the first chamber, such that it does not substantially flow or move when bulk fluid is flowed through the first chamber. Alternatively, the gel may be a soluble gel that is dissolved in the bulk fluid, such that the gel flows with the bulk fluid when the bulk fluid liquid flows through the first chamber. In certain examples, the soluble gel is introduced into the chamber and resides there during focusing. As used herein, the term “soluble gel” refers to a gel that is soluble or dissolved in a liquid or fluid, and further refers to gels that form suspensions, emulsions, colloids, and the like. Typically, soluble gels comprise polymers having little or no cross-linking. In certain examples, the gel will be comprised of molecules having a molecular weight of between about 2000 and about 100,000 Daltons. Suitable gels include, for example, linear polyacrylamide, polyvinyl alcohol, methyl cellulose and other derivatized celluloses, and the like. Other suitable molecular sieves include microporous structures composed of either crystalline aluminosilicate, chemically similar to clays and feldspars and belonging to a class of materials known as zeolites, or crystalline aluminophosphates derived from mixtures containing an organic amine or quaternary ammonium salt, or crystalline silicoaluminophosphates which are made by hydrothermal crystallization from a reaction mixture comprising reactive sources of silica, alumina and phosphate, and the like. The person of ordinary skill in the art, given the benefit of this disclosure, will be able to select suitable gels and sieves through routine experimentation, utilizing known methods, for example by the methods described in Ackers et al., “Determination of stoichiometry and equilibrium constants for reversibly associating systems by molecular sieve chromatography,” Proc. Nat. Acad. Sci. USA 53: 342-349 (1965), the entire disclosure of which is hereby incorporated by reference in its entirety for all purposes. Other suitable sieves will be readily apparent to those of ordinary skill in the art, given the benefit of the present disclosure.

In accordance with other examples, all fluid used in operation of the bulk fluid gate comprise buffer. Generally, a higher concentration of buffer stabilizes the protein sample and avoids precipitation. However, as discussed above, high ionic strength means high conductivity of the buffer, which increases the heat generation and power consumption and sets a limit for the highest suitable field strength. Typical field strengths include, for example, 180 to 300 v/cm. Advantageously, the same buffer is used for the first liquid and second liquid, excluding the dissolved gel where a soluble gel is used to ensure the ion balance between the two sides. The buffer in the second chamber goes upward in the electrode chamber, effectively removing the tiny gas bubbles generated at the electrodes and acts as coolant to remove the Joule heat generated. In certain examples, this coolant is then run through a cooling apparatus, such as a cooling bath, heat exchanger, and the like, to remove the heat from the coolant and the coolant is then recycled back into the electrode housing.

Another role of the coolant is to conduct the electric field gradient through the permeable membrane to the first chamber. Suitable bulk fluids and coolants will be readily apparent to those of ordinary skill in the art, given the benefit of this disclosure.

In accordance with an example of a method, an electrophoretic method for focusing a charged analyte is provided. In the method, a device in accordance with the examples above is provided, a first fluid comprising at least one charged analyte is introduced into the first chamber and an electric field gradient, in the presence of bulk fluid flow, is applied to the charged analyte in the first chamber to focus the charged analyte in the electric field gradient, wherein the first chamber optionally contains chromatography media such as, for example, molecular sieve operative to shift the location at which a stationary focused band of a charged analyte forms under a given set of focusing process parameters. The electric field gradient is preferably generated by an electrode array by individually adjusting the electrode voltages of each element of the array. In certain examples, the electric field gradient is dynamically controlled, that is to say the electric field gradient is changed or adjusted while the focusing takes place.

In certain examples, a hydrodynamic force is generated by pumping the first fluid through the first chamber. The bulk fluid typically is a liquid with any suitable flow rate. In accordance with certain exemplary embodiments the flow rates are as follows. In micro-scale embodiments of the devises and methods disclosed here, exemplary flow rates are 0-20 microliters per minute. In micro-bore scale embodiments of the devises and methods disclosed here, exemplary flow rates are 20-100 microliters per minute. In analytical scale embodiments of the devises and methods disclosed here, exemplary flow rates are 1.0 mL/min. to 2.0 mL/min. In preparative scale embodiments of the devises and methods disclosed here, exemplary flow rates are 2.0 to 20.0 mL/min. In process scale embodiments of the devises and methods disclosed here, exemplary flow rates are 20 mL/min and higher. The flow rate is chosen to provide the desired separation, in other words so that the hydrodynamic force counters the electric field gradient at a position between the weakest and the strongest part of the electric field. In this fashion, the analyte will be retained within the first chamber. Factors that affect the choice of flow rate include, for example, the viscosity and density of the liquid, strength of the electric field gradient, net charge of the analyte, etc. Suitable flow rates will depend in part upon the electric field gradient that is chosen. Suitable flow rates can be readily selected by those skilled in the art, given the benefit of this disclosure.

Certain examples of the devices and methods herein are suited for focusing and separating charged analytes. Charged analytes that can be focused include, e.g., charged polymers, carbohydrates, and biological analytes, such as proteins, peptides, oligonucleotides, polynucleotides, hormones, biomarkers, and the like, and mixtures of any of these. In particular, charged analytes which have similar charge to mass ratios, such as DNA, RNA, etc., can be separated and focused on the basis of differences in their respective molecular weights.

In accordance with certain examples, analytes with little or no net charge can be complexed with to charged carriers, for example, as discussed above, micelles and liposomes, can also be focused and separated with the device.

For example, proteins that exhibit little net charge can form a complex with a charged carrier such that the protein acquires the charge of the charged carrier.

In certain examples, a detergent, for example sodium dodecyl sulfate (SDS), is used as the charged carrier. Without wishing to be bound to a theory, it is presently believed that the SDS binds strongly to protein molecules and “unfolds” them into semi-rigid rods whose lengths are proportional to the length of the polypeptide chain, and hence approximately proportional to molecular weight. Because of the magnitude of the charge of the bound detergent molecules, the protein complexed with such a detergent takes on a high net charge.

In certain examples, electrophoretic devices and methods are provided for focusing a charged analyte and for simultaneously focusing and separating multiple charged analytes. The device comprises a first chamber, as discussed above; an electrode housing that includes an inlet for introducing a second liquid into the electrode housing and an outlet for exiting the second liquid from the electrode housing; and permeable material separating the first and second chambers. The method of separating charged analytes comprises introducing a first fluid comprising a plurality of charged analytes into the bulk fluid flow gate, flowing bulk fluid into the first chamber and applying an electric field gradient to the charged analyte to focus the charged analyte in the electric field gradient into stationary focused bands of charged analyte. In this example, it will be understood that the focusing and separation of these devices and methods occur simultaneously.

While numerous examples of the methods and devices have been illustrated and described, it will be appreciated that various modifications and additions can be made to such examples without departing from the spirit and scope of the methods and devices as defined by the following claims. If any conflict should arise between the present disclosure and the disclosures of the application incorporated by reference, it is intended that the present disclosure be controlling.

1. A bulk fluid flow gate comprising:
a first fluid flow chamber; and
at least one electrode operative when energized to generate an electric field in the first fluid flow chamber;
wherein the first fluid flow chamber comprises
a first fluid inlet port configured to receive bulk fluid flow into the first fluid flow chamber,
a first fluid outlet port configured to pass bulk fluid from the first chamber,
a second fluid inlet port configured to receive sample fluid flow into the first fluid flow chamber at a location between the first fluid inlet port and the first fluid outlet port, and
a second fluid outlet port configured to pass fluid from the first fluid flow chamber, the first fluid outlet port and the second fluid outlet port being on opposite sides of the first fluid inlet port,
the bulk fluid flow gate when receiving a bulk fluid flow into the first fluid flow chamber via the first fluid inlet port and simultaneously a sample fluid flow into the first fluid flow chamber via the second inlet port, presenting greater hydrodynamic resistance to passing fluid from the first fluid flow chamber via the second outlet port than via the first fluid outlet port.

2. The bulk fluid flow gate of claim 1 wherein the first fluid flow chamber is a microscale chamber.

3. The bulk fluid flow gate of claim 1 wherein the second fluid inlet port is configured to receive fluid flow into the first fluid flow chamber at a flow rate lower than the first fluid inlet port.

4. The bulk fluid flow gate of claim 1 wherein at least a pair of electrodes is positioned proximate the first fluid flow chamber, being operative when energized to generate an electric field operative in the first fluid flow channel to move charged analyte received into the first fluid flow chamber via the second inlet port toward the second outlet port through a fluid flowing from the first inlet port to the first outlet port.

5. A bulk fluid flow gate comprising:
at least one electrode for generating an electric field;
a first chamber in communication with the at least one electrode, the first chamber comprising:
a first entry port for introducing bulk fluid into the first chamber,
a first exit port for exiting of bulk fluid from the first chamber,
a second entry port positioned between the first entry port and the first
exit port, the second entry port for introducing sample into the first
chamber, and
a second exit port,
in which bulk fluid introduced through the first entry port experiences substantially greater hydrodynamic resistance at the first exit port than at the second exit port.

6. (canceled)

7. The bulk fluid flow gate of claim 5 in which the bulk fluid flow gate comprises an electrode array.

8. The bulk fluid flow gate of claim 5 in which the first entry port is positioned at an obtuse angle to the axial direction of the first chamber.

9. The bulk fluid flow gate of claim 5 in which the first chamber further comprises separation media selected from the group consisting of molecular sieves, ion-exchange media, and size exclusion media.

10. The bulk fluid flow gate of claim 5 in which the first exit port is positioned downstream from the first entry port and the second entry port, and the second exit port is positioned upstream from the first entry port, the second entry port and the first exit port.

11. (canceled)

12. The bulk fluid flow gate of claim 5 in which each of the first and second exit ports is positioned parallel to the axial direction of the first chamber.

13. The bulk fluid flow gate of claim 5 further comprising an electrode housing containing the at least one electrode.

14. (canceled)

15. A method comprising:
providing a bulk fluid flow gate comprising:
at least one electrode for generating an electric field, a first chamber in communication with the at least one electrode, the first chamber comprising an first entry port, a first exit port, a second entry port positioned between the first entry port and the first exit port, and a second exit port,
introducing a sample comprising at least one charged analyte into the first chamber through the second entry port;
applying an electric field to the first chamber; and
introducing bulk fluid into the first chamber through the first entry port, in which the bulk fluid flows substantially against direction of migration of the at least one charged analyte in the electric field of the first chamber, the bulk fluid flowing with sufficient hydrodynamic force such that the hydrodynamic resistance at the first exit port is substantially greater than the hydrodynamic resistance at the second exit port.

16. The method of claim 15 further comprising eluting the charged analyte from the second exit port.

17. The method of claim 15 further comprising eluting the charged analyte from the first exit port.

18. (canceled)

19. The method of claim 15 in which the sample is introduced into the first chamber using an injector.

20. (canceled)

21. The method of claim 15 in which the bulk fluid flow gate comprises an electrode housing containing the at least one electrode.

22. The method of claim 21 further comprising flowing coolant into the electrode housing.

23. The method of claim 15 in which force of the electric field exceeds hydrodynamic force generated by bulk fluid flow so that the analyte migrates towards the second exit port.

24. The method of claim 15 further comprising applying an electric field gradient to the first chamber.

25. (canceled)

26. The method of claim 15 further comprising adding lipids, micelles, detergent or vesicles to the sample prior to introducing the sample into the first chamber.

27.-49. (canceled)
